(19) United States
(12) Patent Application Publication
(10) Pub. No.: US 2007/0159507 A1
(43) Pub. Date: Jul. 12, 2007

(54) Piezoelectric actuator drive control method, piezoelectric actuator drive control apparatus, and electronic device

(75) Inventor: Osamu Urano, Okaya-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/648,665

(22) Filed: Jan. 3, 2007

(30) Foreign Application Priority Data
Jan. 10, 2006 (JP) JP 2006-002795
Aug. 23, 2006 (JP) JP 2006-227220

(51) Int. Cl. B41J 2/015; B41J 2/045

(52) U.S. Cl. 347/20; 347/68

(57) ABSTRACT

A piezoelectric actuator drive control method, piezoelectric actuator drive control device, and electronic device greatly reduce power consumption. The piezoelectric actuator drive control device stores as a speed setting the minimum speed at which a rotor (driven body) turns when driven by the minimum torque required to turn the rotor (S10), and to achieve this speed setting limits the pulse width of the drive signal relative to the reference pulse width of a reference signal (S20). By limiting pulse width to the minimum pulse width required to drive the rotor, the pulse duty of the drive signal in a rectangular wave drive pulse train can be reduced and power consumption can be reduced greatly compared with a drive signal having a 100% pulse duty when the pulse width is not limited. Battery life can therefore be increased.

### BACKGROUND

1. Technical Field

The present invention relates to a drive control method for a piezoelectric actuator, to a drive control apparatus for a piezoelectric actuator, and to an electronic device.

2. Related Art

Piezoelectric devices offer both excellent response and excellent efficiency converting electrical energy to mechanical energy, and piezoelectric actuators (such as ultrasonic motors) that use a vibrator with a piezoelectric device to drive a rotor or other driven body by transferring vibration from the vibrator to the driven body are known from the literature.

Piezoelectric actuators that operate using resonance mode vibration are also known and are expected to be increasingly used in portable electronics due to their small size, thinness, and high output torque.

Driving such piezoelectric actuators is generally controlled by applying a drive signal of alternating rectangular voltage pulses to the piezoelectric device as taught, for example, in Japanese Patent 2506895 (see the middle paragraph of the right column on page 4, and FIG. 5). Japanese Patent 2506895B2 teaches a method of varying the gain of the amplification circuit to change the voltage applied to the piezoelectric actuator in order to suppress current flow through the piezoelectric actuator.

When driving a piezoelectric actuator by applying a regular rectangular pulse train the piezoelectric actuator can be driven with a nearly 100% duty ratio based on a reference pulse width, but this leads to excess power consumption because piezoelectric actuator output is generally sufficiently greater than the torque that is required to drive the rotor. This results in shorter battery life.

While current consumption can be suppressed by adjusting the drive signal voltage as taught in Japanese Patent 2506895B2, circuit efficiency drops in a variable voltage circuit arrangement, power consumption therefore rises, and energy efficiency is thus impaired.

The piezoelectric actuator drive control method, piezoelectric actuator drive control apparatus, and electronic device of the invention significantly reduce power consumption.

### SUMMARY

A piezoelectric actuator drive control method according to a preferred aspect of the invention is a drive control method for a piezoelectric actuator having a vibrator that vibrates when a drive signal is applied to a piezoelectric element and transfers the vibration of the vibrator to a driven body, wherein the vibrator vibrates in a combination of plural vibration modes when a rectangular-wave, single-phase drive signal is applied. The drive control method has steps of: producing the drive signal with a reference pulse width achieving a maximum drive power determined according to the drive characteristics when the piezoelectric actuator drives the driven body; and limiting the drive signal pulse width relative to the reference pulse width to the minimum pulse width that achieves the minimum drive power required to drive the driven body based on the drive characteristics.

By limiting the pulse width of the drive signal based on a reference pulse width P to a pulse width that can just drive the driven body, the pulse duty of a rectangular wave drive pulse signal can be reduced. Output can therefore be reduced to the level that can drive the driven body by limiting the pulse width of the drive signal even when the output of the piezoelectric actuator is set to a relatively high level in order to sufficiently exceed the required torque when the drive signal pulse width is 100% of the reference pulse width (100% pulse duty) . Power consumption can therefore be reduced greatly below the power consumption level at a 100% pulse duty when the drive signal pulse width is not limited. The invention can therefore greatly extend the life of a battery used as the power source of an piezoelectric actuator.

The reference pulse width of the drive signal is set to the greatest pulse width (100% duty) achieving the maximum drive power afforded by the drive characteristic of the piezoelectric actuator. This maximum drive power is determined from the output required from the piezoelectric actuator, the inertia of the driven body, and pressure between the driven body and vibrator, for example.

The predetermined drive power can be expressed in terms of driven body movement (such as rotational velocity when the driven body is a rotor), or current flow through the piezoelectric elements or piezoelectric actuator.

Furthermore, because the vibrator vibrates in a combined mode of plural vibration modes as a result of supplying a single-phase drive signal to the vibrator to which this drive control is applied, construction is simplified and power consumption is reduced compared with an arrangement that uses a multiple phase drive signal.

When the drive signal pulse is limited to the shortest pulse, the objective of driving the driven body can be achieved while also minimizing power consumption as a result of the piezoelectric actuator outputting the minimum drive power. More particularly, the invention is effective for simply driving a driven body irrespective of the drive speed.

In the piezoelectric actuator drive control method of the invention the pulse width of the drive signal relative to the reference pulse width preferably decreases as the drive power needed to move the driven body decreases.

This further reduces power consumption as the specific drive power needed to move the driven body decreases. In other words, the effect of reducing power consumption in the low speed range is even greater when the driven body is a rotor.

Furthermore, by limiting the drive signal pulse width so that the drive signal pulse width relative to the reference pulse width decreases as the specific required drive power decreases, power consumption can be reduced when the driven body accelerates, such as when the driven body starts moving, because when the driven body accelerates the pulse width is limited to the pulse width corresponding to the initial speed after the driven body starts moving.

When controlling driving a piezoelectric actuator for driving an indicating member such as the hands of a timepiece or a rotating dial, such acceleration occurs when resetting (zeroing) chronograph hands, advancing a reserve power indicator, or advancing the hands to set an alarm, for example. The drive control method of the invention can be widely used in such timepieces having a chronograph, reserve power, or alarm functions, for example.

Because such operations can be driven using a short pulse width (low duty rate), sudden acceleration and deceleration can be prevented through substantially all drive phases without applying a brake by unit of friction between the driven body and the piezoelectric actuator. As a result, wear where the piezoelectric actuator contacts the driven body can be reduced.

In the piezoelectric actuator drive control method of the invention the vibrator is substantially rectangular in plan view; and the plural vibration modes of the vibrator are a longitudinal vibration mode of expansion and contraction lengthwise to the vibrator and a sinusoidal vibration mode of expansion and contraction at an angle to the longitudinal vibration.

The phase difference between the longitudinal vibration and sinusoidal vibration causes a portion of the vibrator to move on an elliptical path, thereby enabling driving a rotor or other driven body with high efficiency while using a simple drive method using a single-phase drive signal.

Yet further preferably, the piezoelectric actuator drive control method sweeps the drive signal pulse width and acquires an appropriate pulse width that achieves a specified drive power; and controls the drive signal to the appropriate pulse width.

This aspect of the invention can thus determine the appropriate pulse width based on actual measurements, control the drive signal to this appropriate pulse width, and thereby reliably achieve the desired drive power.

Yet further preferably, the piezoelectric actuator drive control method initializes the drive signal pulse width at startup to the appropriate pulse width that achieves a specified drive power.

Compared with setting the initial pulse width to 0%, the method of the invention produces drive power near the specified drive power from the start and the driven body therefore reaches a steady state more quickly. Power consumption can therefore be reduced without losing startup speed.

Yet further preferably, the piezoelectric actuator drive control method sets the appropriate pulse width to the drive signal pulse width at which driven body operation was stable when the driven body was driven after the last startup [through [sic?] the previous startup].

By updating the appropriate pulse width based on steady state operation when the driven body was driven after the last startup, the drive power and power consumption can be optimized for changes in load, for example.

The appropriate pulse width can also be updated each time operation starts based on the steady drive state following the last startup.

The appropriate pulse width can also be set based on the pulse widths of the plural drive signals used to drive the driven body in a steady state following a plurality of startup operations.

The appropriate pulse width can thus be optimized by averaging the pulse width from a plurality of drive operations, and drive power and power consumption can therefore be further optimized.

Yet further preferably, the piezoelectric actuator drive control method adjusts the drive signal pulse width based on detecting a drive state of the piezoelectric actuator.

By controlling driving according to the drive state, the driven body can be driven stably even when the load varies.

The drive state of the piezoelectric actuator that is detected to adjust the pulse width is set based on, for example, current flow to the piezoelectric actuator or movement of the driven body, such as the speed of a rotor.

In addition to detecting the piezoelectric actuator drive state to drive a driven body steadily at a constant speed, speed control enabling variably controlling movement of the driven body can also be afforded by providing a piezoelectric actuator current detector, a current control value generator for a particular speed, and a controller for controlling current flow to the piezoelectric actuator based on the detected current and the current control value, and adjusting the pulse width according to controller output. A minimum pulse width and a maximum pulse width enabling driving the driven body are set for each speed, and the drive signal pulse width is limited relative to the reference pulse width.

Instead of controlling the pulse width based on current detection, a detector for detecting movement of the driven body, a motion control value generator for a particular speed, and a controller for controlling motion based on the detected movement and the control value can be used to adjust the pulse width. The pulse width could also be adjusted based on both the detected current and the detected movement of the driven body.

Yet further preferably, in addition to a drive process of limiting the drive signal pulse width to a reference pulse width the piezoelectric actuator drive control method also has an initialization process including an optimum phase difference acquisition step for frequency sweeping the drive signal to find the phase difference between the drive signal and a detection signal denoting the detected drive state as an optimum phase difference that achieves a predetermined drive state; and a phase difference inversion detection step for detecting the phase difference between the drive signal and detection signal while frequency sweeping the drive signal in a predetermined direction through a predetermined range that includes the frequency achieving the predetermined drive state, and detecting the phase difference inversion frequency at which the detected phase difference returns to the optimum phase difference. The drive process causes the drive signal frequency to track the phase difference by limiting the drive signal frequency so that the drive signal frequency does not go to a clamping frequency that is set to a value on a specific drive state side of the phase difference inversion frequency, detecting the phase difference between the drive signal and detection signal, and increasing or decreasing the drive signal frequency based on whether the phase difference is greater than or less than the optimum phase difference. The initialization process executes at a predetermined frequency to update the optimum phase difference and phase difference inversion frequency.

Acquisition of the optimum phase difference used for initialization repeats at a predetermined frequency to update and adjust the optimum phase difference to correct for change in the appropriate optimum phase difference needed to achieve the desired drive state due, for example, to a change in pressure between the vibrator and driven body resulting from wear and individual differences in contact pressure, or due to temperature change resulting from continuously driving the piezoelectric actuator. Drive can therefore be controlled appropriately based on this optimum phase difference, and the desired drive efficiency can be achieved at the appropriate drive power (torque) required to drive the driven body.

This specific acquisition frequency can be set to a specific period of multiple minutes or multiple hours, for example, or defined in terms of the number of times the piezoelectric actuator starts or a particular operation occurs.

The initialization process also detects the phase difference inversion point. More specifically, the frequency at which the phase difference reverses at the initial (updated) optimum phase difference set in the initialization step is detected so that the phase difference inversion frequency is also updated when the optimum phase difference is updated.

This phase difference inversion can be attributed to variations in vibrator assembly and the combined vibration phases of the plural vibration modes, and is described in FIG. 30. More specifically, as shown in to FIG. 30, assuming that the desired vibration characteristic can be achieved at optimum drive state G, there is an inversion point Pt where the target phase difference θ in the optimum drive state G is achieved again when sweeping the drive frequency at a specific bandwidth in a specific direction. The tracking direction of the drive frequency based on the size of the phase difference to the target phase difference reverses at approximately this inversion point Pt (this is referred to below as a “phase difference inversion” or “reversing” phenomenon), and the size of phase difference relative to the target phase difference θ increases in range U2 adjacent to drive range U1 that is used for driving and includes optimum drive state G. As a result, the drive frequency changes in the direction opposite the appropriate direction, that is, rises, in order to bring the phase difference closer to the target phase difference θ. Drive control therefore becomes extremely unstable.

To address this phase difference inversion problem the drive control method of the invention has a phase difference inversion detection step. This phase difference inversion step more particularly sweeps the drive signal frequency range while detecting the phase difference between the drive signal and detection signal, and detects the frequency at which the phase difference reverses when the phase difference reaches the optimum phase difference again as the phase difference inversion frequency. During drive control after initialization, the drive frequency is limited so that the drive signal frequency does not go to the clamping frequency that is set based on the phase difference inversion frequency while controlling the drive signal frequency to track the phase difference in order to prevent the size of the phase difference from reversing relative to the optimum phase difference. Changing the drive frequency in the wrong direction as a result of a reversal of the phase difference evaluation can thus be prevented and stable drive control can be applied. Note that the phase difference inversion frequency and clamping frequency can be the same.

The present invention can thus accommodate changes in the resonance point and the optimum phase difference due to temperature change or the effects of aging, such as wear, and when the phase difference inverts during a frequency sweep as a vibration characteristic of the piezoelectric actuator. The application range of piezoelectric actuators can therefore be further increased (including long term continuous operation) and reliability can be improved regardless of the environment in which the piezoelectric actuator is used and how long the piezoelectric actuator is driven continuously, and cost can be reduced.

Another aspect of the invention is a drive control device for a piezoelectric actuator having a vibrator that vibrates when a drive signal is applied to a piezoelectric element and transfers the vibration of the vibrator to a driven body wherein the vibrator vibrates in a combination of plural vibration modes when a rectangular-wave, single-phase drive signal is applied. The drive control device has a drive signal source for producing the drive signal with a reference pulse width achieving a maximum drive power determined according to the drive characteristics when the piezoelectric actuator drives the driven body; and a control unit for limiting the drive signal pulse width relative to the reference pulse width to the minimum pulse width that achieves the minimum drive power required to drive the driven body based on the drive characteristics.

This aspect of the invention enables greatly reducing power consumption as a result of limiting the drive signal pulse width relative to the reference pulse width to a level enabling driving the driven body and reducing the pulse duty of the drive signal in a rectangular wave drive pulse train.

Furthermore, because the vibrator vibrates in a combined mode of plural vibration modes as a result of supplying a single-phase drive signal to the vibrator to which this drive control is applied, construction is simplified and power consumption is reduced compared with an arrangement that uses a multiple phase drive signal.

When the drive signal pulse is limited to the shortest pulse, the objective of driving the driven body can be achieved while also minimizing power consumption as a result of the piezoelectric actuator outputting the minimum drive power.

In a preferred aspect of the piezoelectric actuator drive control device according to the present invention the vibrator is substantially rectangular in plan view; and the plural vibration modes of the vibrator are a longitudinal vibration mode of expansion and contraction lengthwise to the vibrator and a sinusoidal vibration mode of expansion and contraction at an angle to the longitudinal vibration.

The phase difference between the longitudinal vibration and sinusoidal vibration causes a portion of the vibrator to move on an elliptical path, thereby enabling driving a rotor or other driven body with high efficiency while using a simple drive method using a single-phase drive signal.

Yet further preferably, the piezoelectric actuator drive control device according to the present invention has a storage unit for storing an appropriate pulse width that achieves the specified drive power.

By storing the appropriate pulse width in a storage unit the drive signal pulse width can be initialized to the appropriate pulse width at startup, and power consumption can be reduced without sacrificing startup speed.

A new appropriate pulse width can also be determined during the drive process to update the appropriate pulse width stored in the storage unit, thereby enabling appropriate drive control even when the load varies, for example, and thus stabilizing drive. The appropriate pulse width can be updated at a predetermined frequency, such as a certain period of time or a certain count.

Furthermore, by storing the pulse width of the drive signal when the driven body reaches a steady state or the startup process ends as the appropriate pulse width in the storage unit, the drive signal can be initialized according to the stored appropriate pulse width when the drive operation is started the next time. Both drive power and power consumption can thus be optimized.

If a value indicating motion of the driven body (such as the speed of a rotor) or the current flow to the piezoelectric elements or piezoelectric actuator, for example, is used to indicate the specific drive power used for drive control, this value can be stored in the storage unit.

Yet further preferably, the piezoelectric actuator drive control device of the invention also has a detection unit for detecting the drive state of the piezoelectric actuator, and the control unit adjusts the drive signal pulse width based on the drive state.

By controlling drive according to the drive state, the driven body can be driven steadily even when the load varies, for example.

The piezoelectric actuator drive control device according to another aspect of the invention has an initialization unit comprising a phase difference detection unit for detecting a phase difference between the drive signal and a detection signal denoting the drive state detected by the detection unit, an optimum phase difference acquisition unit for frequency sweeping the drive signal to find an optimum phase difference that is the phase difference achieving a predetermined drive state based on phase difference detection by the phase difference detection unit, and a phase difference inversion detection unit for detecting the phase difference between the drive signal and detection signal while frequency sweeping the drive signal in a predetermined direction through a predetermined range that includes the frequency achieving the predetermined drive state, and detecting the phase difference inversion frequency at which the detected phase difference returns to the optimum phase difference; a frequency control unit for setting the drive signal frequency based on the optimum phase difference; and an acquisition frequency control unit for updating the optimum phase difference and the phase difference inversion frequency by executing the process of the initialization unit at a predetermined frequency. The frequency control unit has a clamping unit for limiting the drive signal frequency so that the drive signal frequency does not go to a clamping frequency that is set to a value on a specific drive state side of the phase difference inversion frequency, and causes the drive signal frequency to track the phase difference by limiting the drive signal frequency by unit of the clamping unit while detecting the phase difference by unit of the phase difference detection unit and increasing or decreasing the drive signal frequency based on whether the phase difference is greater than or less than the optimum phase difference.

The invention can thus update the optimum phase difference and phase difference inversion frequency in the initial settings. As a result, the drive control does not become unstable even if the resonance point and optimum phase difference vary due to temperature change or wear over time. In addition, if the phase difference reverses during a frequency sweep of the vibration characteristic of the piezoelectric actuator, the drive signal frequency will not be changed in the wrong direction. In addition to reducing power consumption, the invention thus also affords stable drive control.

An electronic device according to another aspect of the invention has a piezoelectric actuator; a driven body that is driven by the piezoelectric actuator; and the piezoelectric actuator drive control device described above.

Incorporating the piezoelectric actuator drive control device described above affords the same operation and effect in an electronic device according to the present invention.

More particularly, power consumption can be greatly reduced, and battery life can therefore be extended in a battery-operated portable device.

Examples of such portable devices include cell phones, personal digital assistant (PDA) devices, movable toys, cameras, and printers.

An electronic device according to another aspect of the invention is a timepiece having a timekeeping unit and a time display unit for displaying time information kept by the timekeeping unit.

The invention enables using a piezoelectric actuator to drive the wheel train of the timekeeping unit and the indicators of the time display unit with extremely low power consumption, reduces the frequency at which the battery must be replaced, and thus improves convenience.

This also affords full benefit of the advantages of a piezoelectric actuator, including resistance to magnetic effects, high speed response with precision drive, light weight and a thin profile, and high torque.

The piezoelectric actuator drive control device of the invention can be realized as a hardware construction or a software control program.

This control program causes a computer incorporated in the drive control device to function as a detection unit, control unit, phase difference detection unit, initialization unit, frequency control unit, and acquisition frequency control unit, for example.

The resulting control program also affords the same effect as the drive control device of the invention.

The control program can be installed in the computer from a network or a computer-readable data storage medium storing the program.

By incorporating a control program from a recording medium or communication medium such as the Internet in a timepiece or portable device, the operation and effects described above can be achieved by simply changing the control program, and the control program can be incorporated at the time of factory shipping or as desired by the user. This also affords greater use of common parts in different products, and greatly reduces the cost of manufacturing a wide range of products, because timepieces and portable devices having different control methods can be manufactured by simply changing the control program.

[Effect of the Invention]

The present invention can greatly reduce power consumption and extend battery life.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows a timepiece according to a preferred embodiment of the invention.

FIG. 2 is a plan view of the date display device in a preferred embodiment of the invention.

FIG. 3 is an oblique view of the piezoelectric actuator unit in a preferred embodiment of the invention.

FIG. 4 is a plan view of the piezoelectric actuator unit in a preferred embodiment of the invention.

FIG. 5 is a block diagram showing the arrangement of the piezoelectric actuator drive control device in a preferred embodiment of the invention.

FIG. 6A is a graph showing the relationship between drive frequency and impedance and FIG. 6B is a graph showing the relationship between drive frequency and the amplitude of longitudinal vibration and sinusoidal vibration in the vibrator in the preferred embodiment of the invention.

FIG. 7 is a graph showing the drive characteristic when sweeping the drive signal pulse width in a preferred embodiment of the invention.

FIG. 8 is a flow chart of piezoelectric actuator drive control in a preferred embodiment of the invention.

FIG. 9 is a timing chart of piezoelectric actuator drive control in a preferred embodiment of the invention.

FIG. 10 is a graph of power consumption during piezoelectric actuator drive control in a preferred embodiment of the invention.

FIG. 11 is a flow chart of piezoelectric actuator drive control in a first variation of the first embodiment of the invention.

FIG. 12 is a flow chart of piezoelectric actuator drive control in a second variation of the first embodiment of the invention.

FIG. 13 is a block diagram showing the arrangement of the piezoelectric actuator drive control device in a fourth variation of the first embodiment of the invention.

FIG. 14 shows a timepiece according to a second embodiment of the invention.

FIG. 15 is a block diagram showing the arrangement of a piezoelectric actuator drive control device in this embodiment of the invention.

FIG. 16 is a block diagram showing the arrangement of the controller of a piezoelectric actuator drive control device in this embodiment of the invention.

FIG. 17 is a graph showing the change in phase difference, rotor speed, and current when sweeping the drive signal frequency in a vibrator in this embodiment of the invention.

FIG. 18 is a partial enlargement of the graph in FIG. 17.

FIG. 19 shows a data table stored in the storage unit in this embodiment of the invention.

FIG. 20 is a flow chart of the optimum phase difference acquisition step and phase difference inversion detection step of the piezoelectric actuator drive control device in this embodiment of the invention.

FIG. 21 is a flow chart of the drive step of a piezoelectric actuator drive control device in this embodiment of the invention.

FIG. 22 is a flow chart of the low power consumption drive process P6 of the drive control device in this embodiment of the invention.

FIG. 23 shows the change in the piezoelectric actuator drive characteristic in this embodiment of the invention.

FIG. 24 is a graph of the piezoelectric actuator drive characteristic in this embodiment of the invention.

FIG. 25 is a graph of the drive characteristic of the piezoelectric actuator in this embodiment of the invention without drive frequency limiting for comparison with the graph in FIG. 24.

FIG. 26 is a flow chart of piezoelectric actuator drive control in a first variation of the second embodiment of the invention.

FIG. 27 is a flow chart of piezoelectric actuator drive control in a third variation of the second embodiment of the invention.

FIG. 28 is a block diagram showing the arrangement of the drive control device in a third embodiment of the invention.

FIG. 29 is a flow chart of the optimum phase difference acquisition step of the piezoelectric actuator drive control device in this embodiment of the invention.

FIG. 30 is a graph showing change in phase difference, rotor speed (drive), and current when sweeping the drive signal frequency.

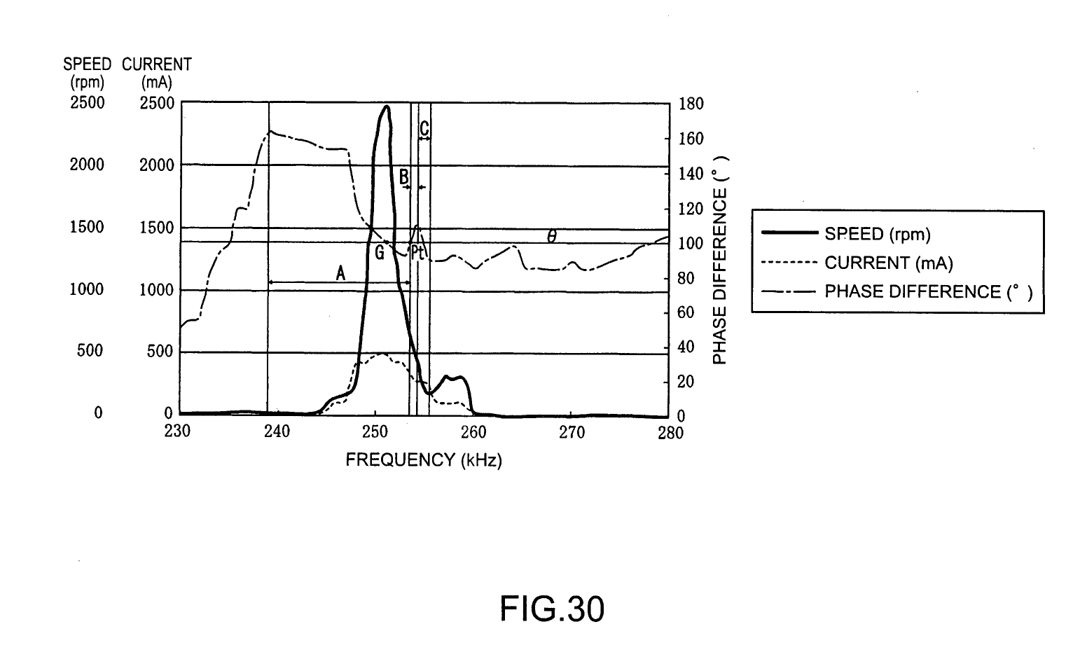

### DESCRIPTION OF EXEMPLARY EMBODIMENTS

### First embodiment

A first embodiment of the invention is described below with reference to the accompanying figures.

Note that in the second and later embodiments described below parts that are functionally the same as parts in the first embodiment are identified by the same reference numerals and further description thereof is omitted or abbreviated.

### 1. General Configuration

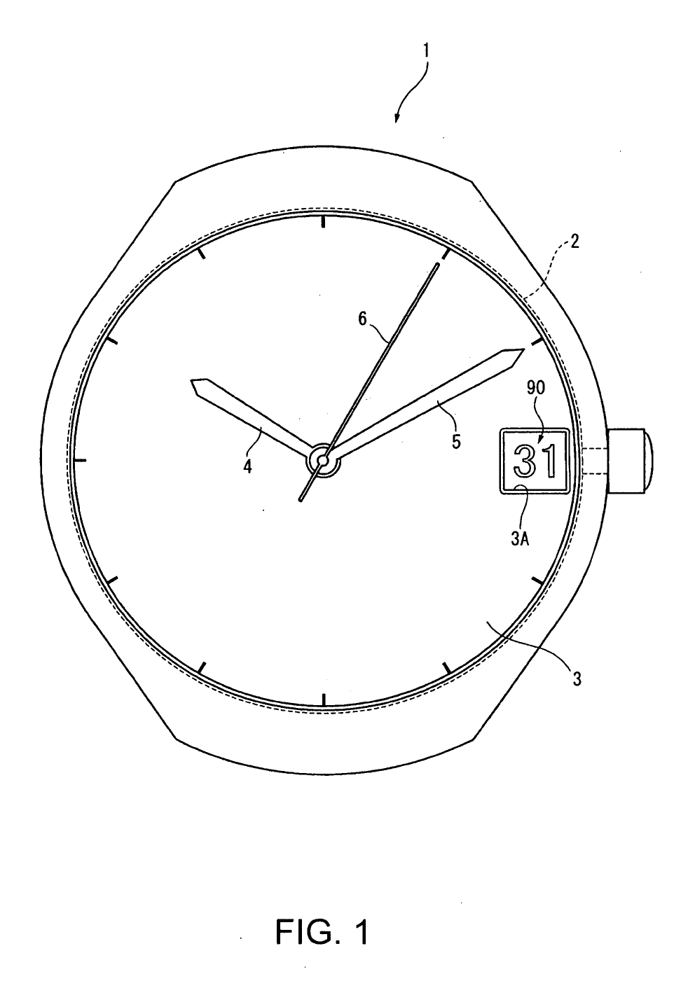

FIG. 1 is a plan view of an electronic timepiece 1 according to the present embodiment. This electronic timepiece 1 is a wristwatch with a movement 2 as the timekeeping unit, a dial 3, hour hand 4, minute hand 5, and second hand 6 as a time information display unit for displaying the time, and a date display device 90 for displaying the date in a window 3A rendered in the dial 3.

### 2. Arrangement of the Date Display Device

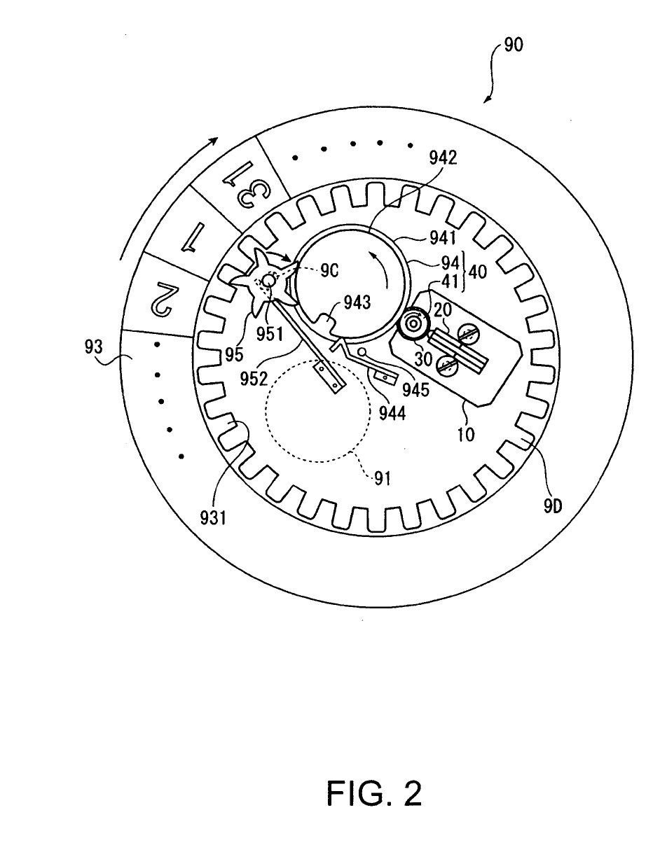

FIG. 2 is a plan view of the date display device 90. The date display device 90 includes a piezoelectric actuator 20, a rotor 30 that is a driven body that is driven rotationally by the piezoelectric actuator 20, a speed-reducing wheel train 40 that transfers torque from the rotor 30 while reducing the speed of rotation, and a date wheel 93 that is rotated by the drive power transferred through the speed-reducing wheel train 40.

The speed-reducing wheel train 40 includes a wheel 41 that is disposed coaxially to the rotor 30 and rotates in unison with the rotor 30, a date-turning intermediate wheel 94 that engages wheel 41, and a date-turning wheel 95.

The piezoelectric actuator 20, rotor 30, date-turning intermediate wheel 94, and date-turning wheel 95 are supported on base plate 9D.

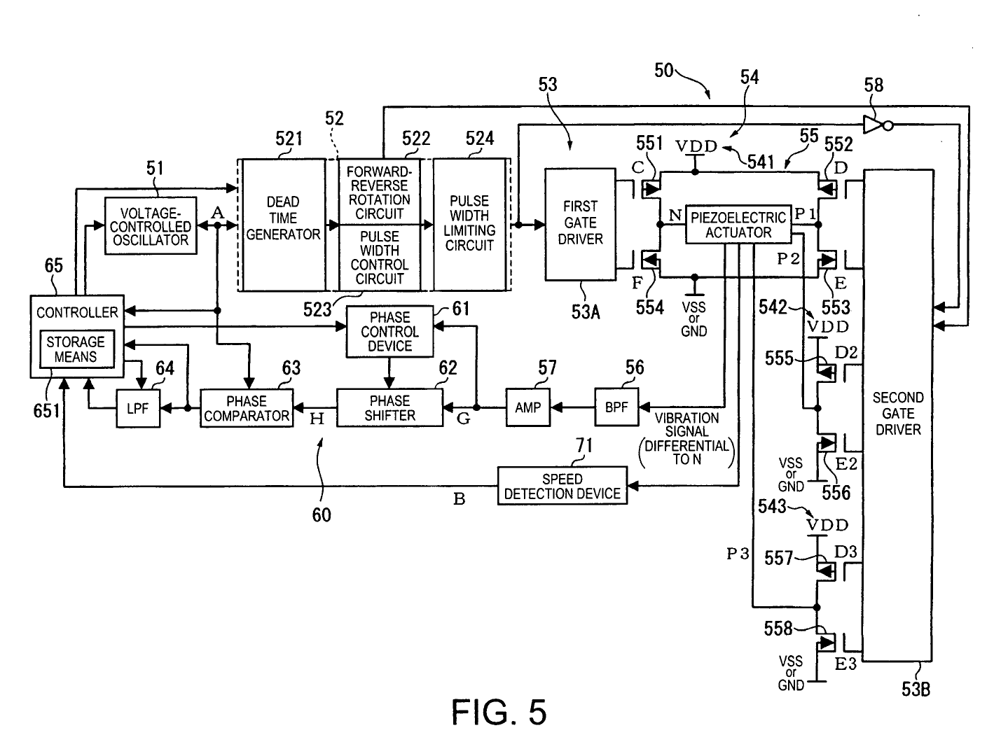

Below (that is, on the back side of) the base plate 9D are disposed a stepping motor (not shown in the figure) that operates according to a pulse train emitted by a crystal vibrator, a movement wheel train (not shown in the figure) that is connected to the stepping motor for driving the hour hand 4, minute hand 5, and second hand 6, and a battery 91 as the power source. The battery 91 supplies power to the stepping motor and piezoelectric actuator 20, and various circuits including the drive control device 50 (see FIG. 5) of the piezoelectric actuator 20.

The date-turning intermediate wheel 94 has a large-diameter part 941 and a small-diameter part 942. The small-diameter part 942 is tubular, slightly smaller in diameter than the 941, and has a substantially square notch 943 rendered in the outside surface. This small-diameter part 942 is affixed coaxially to the large-diameter part 941. The wheel 41 on the top portion of the rotor 30 engages the large-diameter part 941. The date-turning intermediate wheel 94 composed of the large-diameter part 941 and small-diameter part 942 therefore rotates in conjunction with the rotor 30.

A flat spring 944 is disposed to the base plate 9D beside the date-turning intermediate wheel 94 with the base portion of the flat spring 944 fixed to the base plate 9D and the distal end bent to form a substantially V-shaped unit. The distal end part of the flat spring 944 is disposed so that it can enter and leave the notch 943 in the date-turning intermediate wheel 94. A contact 945 is also disposed near the flat spring 944 so that when the date-turning intermediate wheel 94 turns and the distal end part of the flat spring 944 enters the notch 943 the contact 945 makes contact with the flat spring 944. A predetermined voltage is applied to the flat spring 944, and when the flat spring 944 contacts the contact 945, the voltage is also applied to the contact 945. The date-turning state can thus be detected and the amount of date wheel 93 rotation in one day can be detected by detecting the contact 945 voltage.

It will be obvious that detecting rotation of the date wheel 93 is not limited to using this flat spring 944 and contact 945, and can be done using an arrangement that detects rotation of the rotor 30 or date-turning intermediate wheel 94 and outputs a specific pulse signal. More specifically, various known arrangements using a photoreflector, photointerrupter, MR sensor, or other type of rotational encoder can be used.

The date wheel 93 is ring-shaped and has an internal gear 931 rendered on the inside circumference. The date-turning wheel 95 has five teeth and engages the internal gear 931 of the date wheel 93. A shaft 951 is disposed at the center of the date-turning wheel 95, and this shaft 951 turns freely in a through-hole 9C rendered in the base plate 9D. The through-hole 9C is an oblong hole with the long axis following the circumferential direction of the date wheel 93. The date-turning wheel 95 and shaft 951 are urged to the right as seen in FIG. 2 by a flat spring 952 affixed to the base plate 9D. The urging force of the spring 952 suppresses play in the date wheel 93.

### 3. Arrangement of the Piezoelectric Actuator

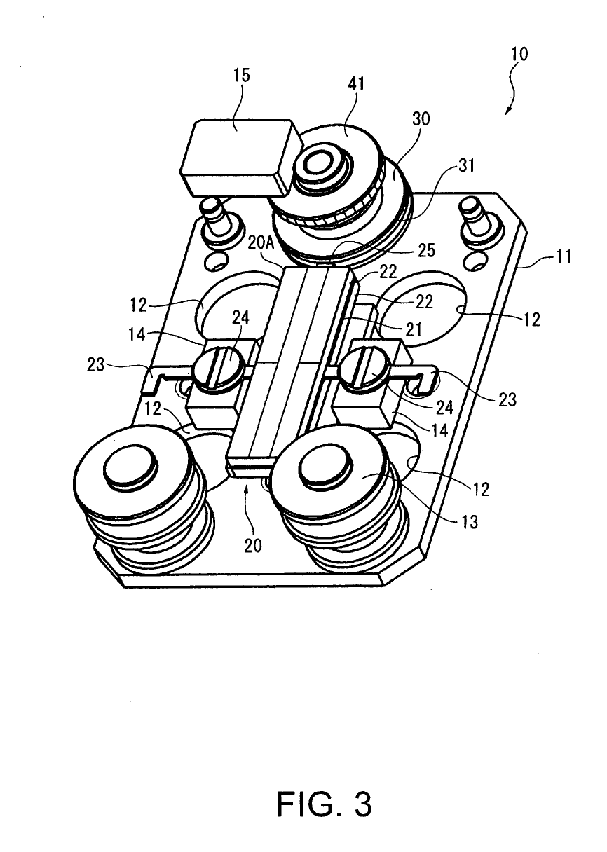

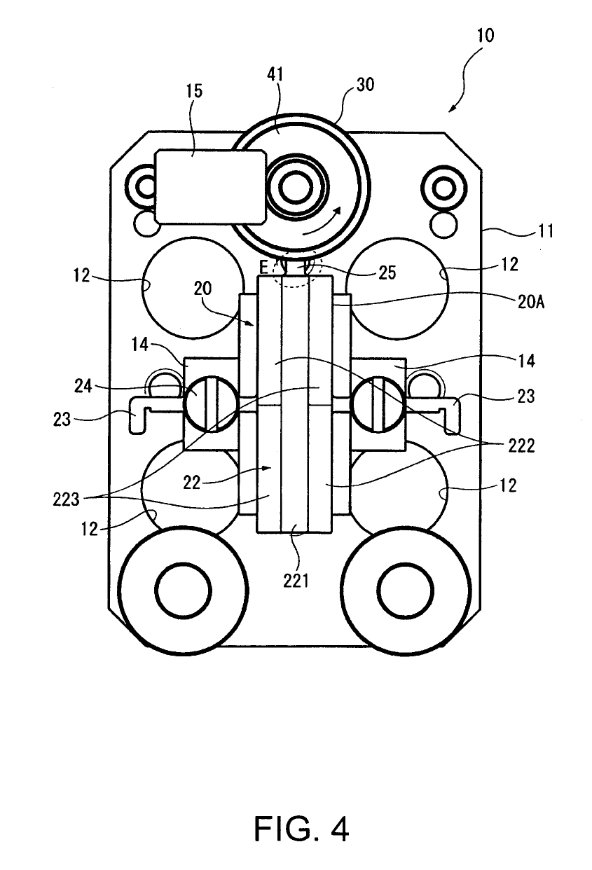

As shown in FIG. 3 and FIG. 4 the piezoelectric actuator 20, rotor 30, and wheel 41 together render a piezoelectric actuator unit 10.

The piezoelectric actuator unit 10 includes a support plate 11 that is fixed, for example, to the main plate of the electronic timepiece 1, the piezoelectric actuator 20 affixed to the support plate 11, and the rotor 30 and wheel 41 disposed freely rotatably on the support plate 11. Rotation of wheel 41 is rendered detectable by a rotation sensor 15 disposed as a detection unit above the wheel 41.

Holes 12 are rendered in the support plate 11 to reduce the weight, and the support plate 11 is fixed to the main plate, for example, by means of a screw or other fastener 13. Spacers 14 to which the piezoelectric actuator 20 is attached are affixed to the support plate 11.

### 4. Arrangement of the Piezoelectric Actuator

The piezoelectric actuator 20 includes a substantially rectangular reinforcement plate 21 and a vibrator 20A composed of piezoelectric elements 22 bonded to both sides of the reinforcement plate 21.

An arm part 23 is formed projecting to the side from substantially the center of each long side of the reinforcement plate 21, and these arm parts 23 are fastened by screws 24 to the spacers 14. The reinforcement plate 21 that has the arm parts 23 is made from a conductive metal, and the arm parts 23 are also used as electrodes for applying drive signals to the piezoelectric elements 22.

A contact part 25 protruding in the lengthwise direction of the reinforcement plate 21 is formed at one lengthwise end portion of the reinforcement plate 21, and more specifically at the end opposing the rotor 30, and this contact part 25 touches the side of the rotor 30. With the contact part 25 disposed to the rotor 30 so that the contact part 25 contacts the outside surface of the rotor 30 with a predetermined force, the contact part 25 is urged by a spring or other suitable urging unit so that an appropriate amount of friction works between the contact part 25 and the side of the rotor 30 and vibration of the vibrator 20A is efficiently transferred to the rotor 30.

A channel 31 (FIG. 3) is formed in the outside surface of the rotor 30 in this embodiment of the invention and the contact part 25 is positioned in this channel 31. If shock is applied to the piezoelectric actuator 20 such as when the electronic timepiece 1 is dropped, this channel 31 acts as a guide preventing the contact part 25 from separating from the contact surface of the rotor 30.

The piezoelectric elements 22 are substantially rectangular flat pieces that are bonded to the substantially rectangular area on both sides of the reinforcement plate 21. Electrodes are formed on both sides of the piezoelectric elements 22 by plating, sputtering, vapor deposition, or other method

A single electrode is formed on the reinforcement plate 21 side surface of the piezoelectric elements 22, and the piezoelectric elements 22 are connected to the drive control device 50 (FIG. 5) through the reinforcement plate 21 and arm parts 23 that contact this single electrode.

Five segment electrodes are formed on the outside surface of the piezoelectric elements 22 as shown in FIG. 4. More specifically, the electrodes on the exposed surface sides of the piezoelectric elements 22 are divided into three equal parts widthwise to the piezoelectric elements 22, and the center electrode is used as drive electrode 221. The electrodes on each side of the drive electrode 221 are divided substantially in half lengthwise to the piezoelectric elements 22, and the electrodes at opposite diagonal corners are paired as drive electrodes 222 and drive electrodes 223.

These drive electrodes 221, 222, and 223 are each connected by wire leads to the drive control device 50 (denoted P1 to P3 in FIG. 5), and a voltage is applied between the drive electrodes 221, 222, and 223 and reinforcement plate 21 (N in FIG. 5). The drive control device 50 has three power supplies, one each for applying voltage between drive electrode 221 and reinforcement plate 21, applying voltage between drive electrodes 222 and reinforcement plate 21, and applying voltage between drive electrodes 223 and the reinforcement plate 21.

The drive control device 50 (FIG. 5) and piezoelectric actuator 20 are operated to change the date in this electronic timepiece 1. The drive control device 50 supplies a single-phase drive signal to the piezoelectric actuator 20 to drive the rotor 30 rotationally.

Drive electrodes 222 and 223 of the piezoelectric elements 22 are selectively used according to whether the date is changed as a result of keeping the time or as a result of adjusting the date, and the rotor 30 can be driven rotationally in both directions.

More specifically, when the date is changed due to timekeeping, voltage is applied to drive electrode 221 and drive electrodes 222, and the phase difference between the longitudinal vibration and the sinusoidal vibration produced by the vibrator 20A due to the expansion and contraction of the piezoelectric elements 22 causes the contact part 25 of the vibrator 20A to trace a substantially elliptical path E (FIG. 4) biased to the longitudinal axis of the piezoelectric elements 22. The contact part 25 pushes the rotor 30 during part of this path E and causes the rotor 30 to rotate in the forward direction (denoted by the arrow in FIG. 4).

When the displayed date changes when the date is adjusted, voltage is applied to drive electrodes 223 instead of drive electrodes 222, thus producing a sinusoidal vibration that intersects the longitudinal vibration line symmetrically to the sinusoidal vibration produced when voltage is applied to drive electrodes 222 because drive electrodes 222 and drive electrodes 223 are disposed line symmetrically to the lengthwise axis of the piezoelectric elements 22. The contact part 25 of the vibrator 20A therefore follows a substantially elliptical path that is line symmetrical to and turns in the opposite direction as the path followed when voltage is applied to drive electrodes 222.

When the rotor 30 thus turns the wheel 41 formed in unison with the rotor 30 also turns, and the rotational motion of the wheel 41 is transferred to the date-turning intermediate wheel 94. When a tooth of the date-turning wheel 95 meshes with the notch 943 in the date-turning intermediate wheel 94, the date-turning wheel 95 advances the date wheel 93, and the date displayed by the date wheel 93 changes.

A detection signal denoting the vibration state of the vibrator 20A is detected by the drive electrodes 223 to which the drive signal is not applied when the rotor 30 rotates forward, and is detected by the drive electrodes 222 to which the drive signal is not applied when the rotor 30 rotates in reverse.

The speed of the rotor 30 is also detected by the rotation sensor 15 detecting the speed of the wheel 41. 5. Arrangement of the piezoelectric actuator drive control device

The arrangement of the drive control device 50 of the piezoelectric actuator 20 is described next with reference to FIG. 5.

As shown in FIG. 5 the drive control device 50 has a voltage-controlled vibrator (VCO) 51 as the drive signal source, a pulse control circuit 52, a gate driver 53, a power supply 54, a switching circuit 55, a bandpass filter (BPF) 56, a signal amplifier (AMP) 57, a phase difference detection unit 60, a controller 65 as a control unit, and a speed detection device 71 for detecting the speed of the rotor 30.

The voltage-controlled vibrator 51 is a vibrator that can change the frequency of the output signal according to the applied voltage. The voltage-controlled vibrator 51 generates a reference signal of a predetermined reference pulse width for generating the drive signal of the piezoelectric actuator 20.

The frequency (drive frequency) of the drive signal is determined according to the resonance point of the longitudinal vibration and the resonance point of the sinusoidal vibration of the vibrator 20A.

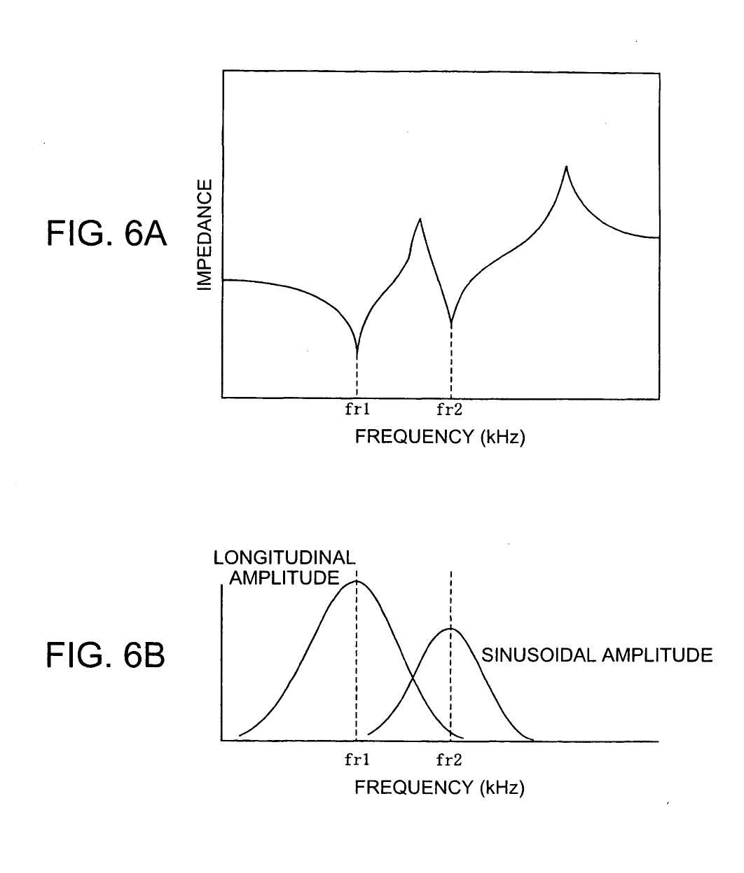

FIG. 6A shows the relationship between the drive frequency of the vibrator 20A and impedance, and FIG. 6B shows the relationship between the drive frequency of the vibrator 20A and the amplitude of the longitudinal vibration and the amplitude of the sinusoidal vibration.

As shown in FIG. 6A, there are two resonance points where impedance is lowest and amplitude is highest relative to the drive frequency. The resonance point where the frequency is lower is the resonance point of the longitudinal vibration, and the resonance point where the frequency is higher is the resonance point of the sinusoidal vibration.

More specifically, if the vibrator 20A is driven between the longitudinal resonance frequency fr1 of the longitudinal vibration and the sinusoidal resonance frequency fr2 of the sinusoidal vibration, the amplitude of both the longitudinal vibration and the sinusoidal vibration is assured and the piezoelectric actuator 20 can be driven with high efficiency. Bringing the longitudinal resonance frequency fr1 and sinusoidal resonance frequency fr2 closer together enables setting a drive frequency that results in a higher longitudinal vibration and sinusoidal vibration amplitude.

Referring again to FIG. 5, the pulse control circuit 52 is a circuit for limiting the pulse width of the drive signal generated by the voltage-controlled vibrator 51 to a reference pulse width based on a command value from the controller 65. The pulse control circuit 52 includes a dead time generator 521 for generating the dead time to control the switching timing of the switching circuit 55 described below and suppress shoot-through current, a forward-reverse rotation circuit 522 for changing the direction of rotor 30 rotation and outputting the appropriate control value, a pulse width control circuit 523 for outputting a pulse-limiting control value, and a pulse width limiting circuit 524 for applying pulse control including inserting dead time every period to regulate the drive signal pulse duty.

The gate driver 53 is a drive circuit for controlling the on/off state of the switching circuit 55 based on the drive signal output from the pulse control circuit 52, and in this embodiment of the invention includes a first gate driver 53A and second gate driver 53B.

The drive signal input from the pulse control circuit 52 to the second gate driver 53B passes inverter (NOT gate) 58, and is thus the inverse of the drive signal input to the first gate driver 53A.

The power supply 54 in this embodiment of the invention has a first power supply 541 that is used when the rotor 30 rotates forward and reverse, a second power supply 542 that is used only when the rotor 30 rotates forward, and a third power supply 543 that is used only when the rotor 30 turns in reverse. These first, second, and third power supplies 541, 542, and 543 apply a voltage of the potential difference between power supply VDD and VSS, or between VDD and GND, to the piezoelectric actuator 20.

The switching circuit 55 includes switches 551, 552, 555, 557, which are p-channel MOS-FET devices, and switches 553, 554, 556, 558, which are n-channel MOS-FET devices. These switches 551 to 558 are controlled to the on or off state by the voltage applied to the gate by first gate driver 53A or second gate driver 53B.

The second gate driver 53B is connected to forward-reverse rotation circuit 522, and drives only switches 552, 553 (FIG. 5, P1) and switches 555, 556 (P2) when the rotor 30 rotates forward.

More specifically, when the rotor 30 turns forward, the first gate driver 53A driving switches 551 and 554, and the second gate driver 53B driving switches 552 and 553 (P1) and switches 555 and 556 (P2), output mutually inverted drive signals, thus setting switches 551 and 552, which are both p-channel MOS-FET devices, to opposite states so that when switch 551 is on, the other switch 552 is off. This also applies to p-channel MOS-FET switches 551 and 555.

The n-channel MOS-FET switches 553 and 554 behave in the same way. That is, when one switch 553 is on, the other switch 554 is off. This also applies to n-channel MOS-FET switches 556 and 554.

When one of serially connected switches 551 and 554 is on, the other is off. Likewise, when one of serially connected switches 552 and 553, or switches 555 and 556, is on, the other is off.

Switches 551 to 554 (or switches 551, 555, 556, 554) are bridge connected to the piezoelectric elements 22 by first gate driver 53A and second gate driver 53B. The switch circuit rendered by the pair of switches 551, 553 (or switches 551, 556) at diagonally opposite parts of the bridge, and the switch circuit rendered by the pair of switches 552, 554 (or switches 555, 554) are alternately switched on/off. As a result, the specific supply voltage applied by the power supply 54 is converted to an alternating rectangular wave voltage and applied to the piezoelectric actuator 20. In other words, first power supply 541 and second power supply 542 apply an alternating voltage to the piezoelectric elements 22 between the drive electrodes 221 and 222 and reinforcing plate 21 (FIG. 3) to drive the rotor 30 in the forward rotating direction.

To drive the rotor 30 in the reverse direction, second gate driver 53B drives switches 557, 558 (P3) instead of switches 555, 556 (P2) so that switches 551, 552, 553, 554 (or switches 551, 557, 558, 554) are bridge connected to the piezoelectric elements 22. The switch circuit rendered by the pair of switches 551, 553 (or switches 551, 558) at diagonally opposite parts of the bridge, and the switch circuit rendered by the pair of switches 554, 552 (or switches 554, 557) alternately switch on/off. In other words, first power supply 541 and third power supply 543 apply an alternating voltage to the piezoelectric elements 22 between the drive electrodes 221 and 223 and reinforcing plate 21 (FIG. 3) to drive the rotor 30 in the reverse rotating direction.

If the serially connected switches 551, 554 or switches 552, 553 (or switches 555, 556 or switches 557, 558) go on simultaneously when switching the on/off state of switches 551 to 558, shoot-through current flows. Because this shoot-through current is not used for driving the piezoelectric actuator 20, it simply wastes power and can result in burning switch devices. The pulse control circuit 52 therefore prevents shoot-through current by waiting a predetermined time (dead time) after turning one switch off before turning the other switch on.

The bandpass filter 56 (single peak) is a filter that passes only those detection signals detected from the vibration state of the piezoelectric actuator 20 that are within a predetermined frequency band, and eliminates signals of all other frequencies.

The detection signal is detected through the drive electrodes 222 or 223 that are not used to supply the drive signal causing the rotor 30 to rotate forward or reverse (see P2 and P3 in FIG. 5). Using the potential of the arm portions 23 (N in FIG. 5) as a reference signal, the detection signal is detected from the potential difference between the reference signal and the potential of the drive electrodes 222, or the reference signal and the potential of the drive electrodes 223, that is, from a difference signal of the drive electrodes 222 or 223 to the arm portions 23.

The detection signal passed by the bandpass filter 56 is amplified by the signal amplifier 57.

The phase difference detection unit 60 includes a phase control device 61, phase shifter 62, phase comparator 63, and low-pass filter (LPF) 64.

The phase control device 61 outputs a control signal to the phase shifter 62 at every second period of the detection signal. The phase shifter 62 shifts the phase of the detection signal a predetermined optimal phase difference amount according to this control signal.

The phase comparator 63 compares the phase of the detection signal output from the phase shifter 62 and the phase of the drive signal output from the voltage controlled vibrator 51, and outputs the phase difference. As noted above, the phase shifter 62 shifts the phase of the detection signal an optimal phase difference amount, and the closer the output of the phase comparator 63 is to zero, the closer the actual phase difference is to the optimal phase difference.

The low-pass filter 64 passes only signals of a frequency less than or equal to a specified frequency, and eliminates signals of a frequency greater than [or equal to, sic] the specified frequency, and functions as an integration circuit.

The phase difference detection unit 60 therefore outputs the difference between the phase of the drive signal and the phase of the detection signal shifted by the phase shifter 62, that is, the deviation (magnitude) to the optimal phase difference, through the low-pass filter 64 to the controller 65.

The controller 65 outputs a voltage signal to the voltage controlled vibrator 51 and a command value to the pulse control circuit 52 to eliminate deviation to the input optimal phase difference, and is rendered with a storage unit 651.

The storage unit 651 stores a speed setting denoting the minimum torque (drive power) required to drive the rotor 30.

This speed setting is determined according to the drive characteristics of the piezoelectric actuator 20.

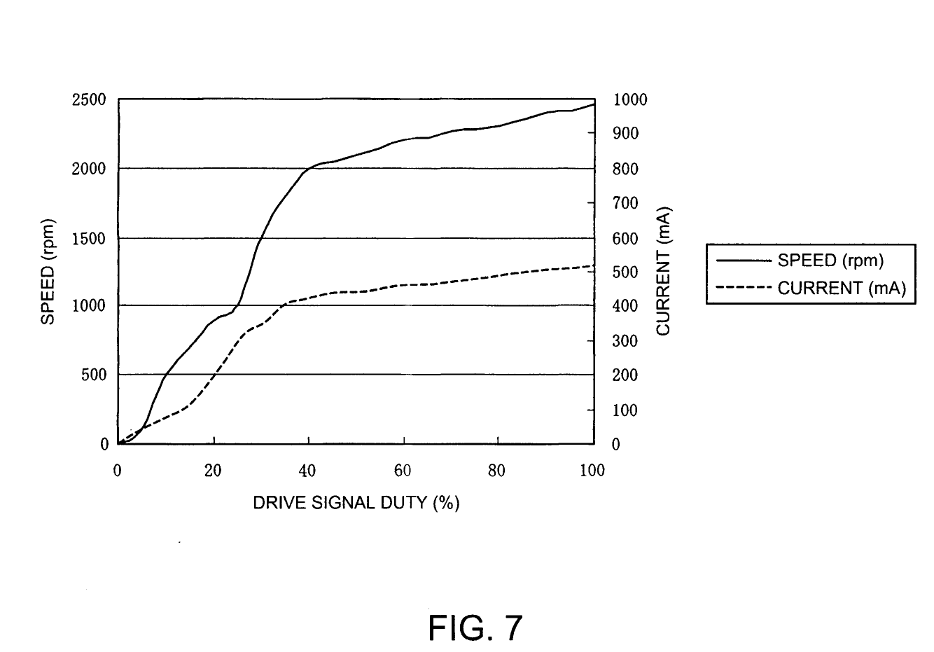

FIG. 7 shows the speed of the rotor 30 when sweeping the pulse width (duty) of the drive signal. Due to such factors as the inertia of the rotor 30, the minimum speed at which the rotor 30 turns to generate the lowest drive power is approximately 600 rpm, and this minimum speed of 600 rpm is stored in the storage unit 651 as the speed setting.

The reference pulse width of the drive signal output by the voltage controlled vibrator 51 is set to the maximum pulse width (100% duty) for generating the maximum drive power enabled by the drive characteristic of the piezoelectric actuator 20. The maximum drive power is determined according to such conditions as the output required from the piezoelectric actuator 20, the inertia of the rotor 30, and the pressure between the rotor 30 and vibrator 20A.

The speed detection device 71 is rendered using a rotation sensor 15 for detecting the speed of the wheel 41 (FIG. 3) rendered in unison with the rotor 30.

### 6. Piezoelectric Actuator Drive Control

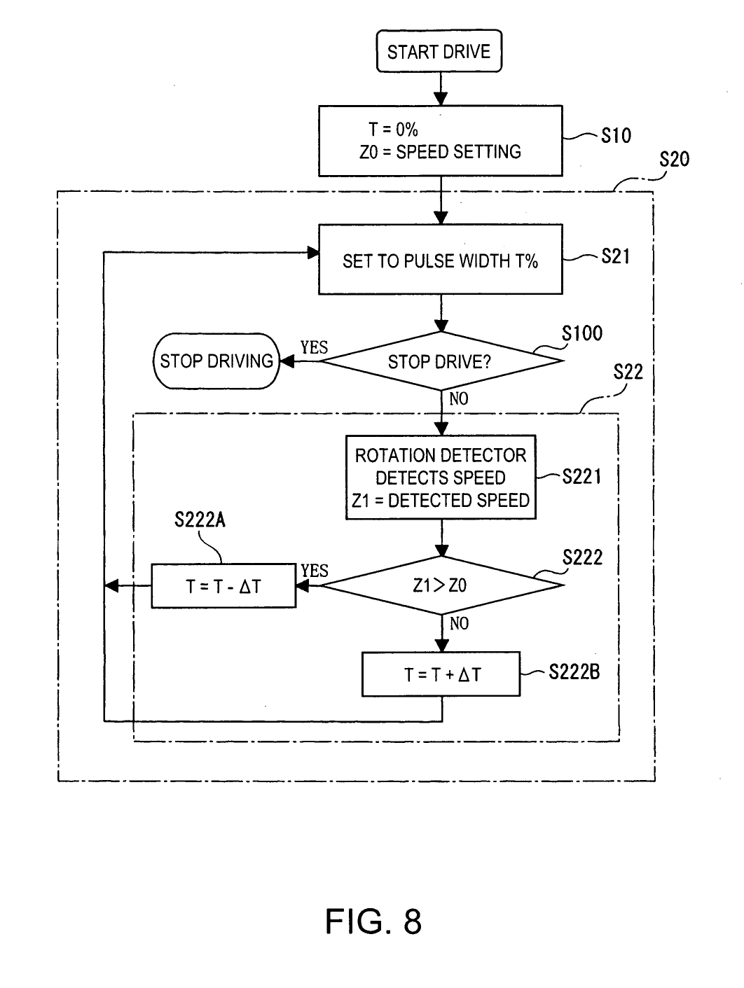

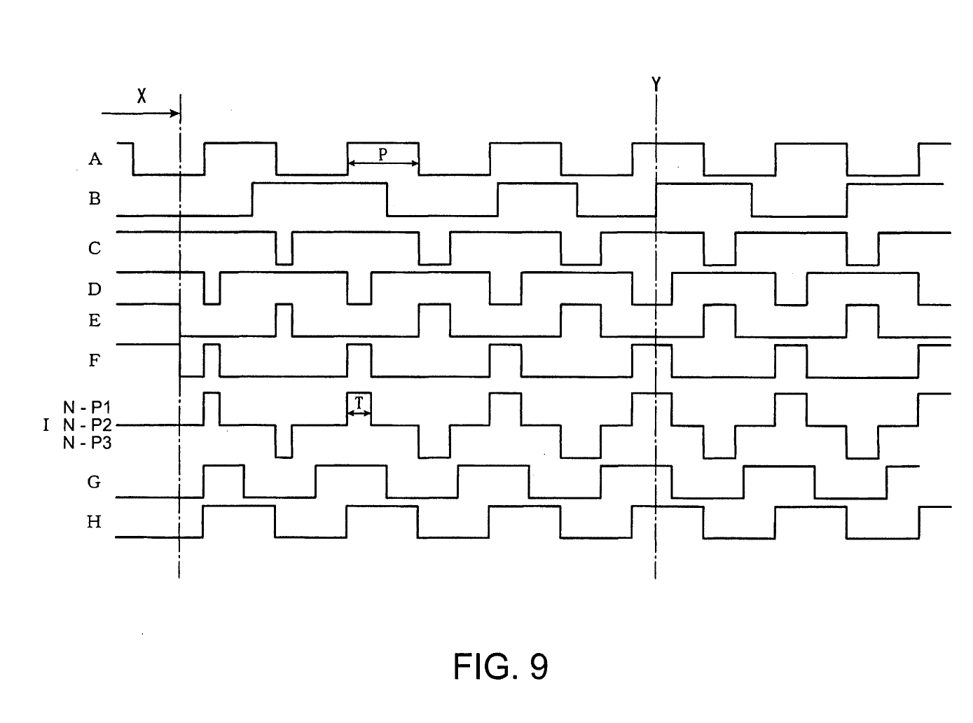

How the drive control device 50 operates the piezoelectric actuator 20 is described next with reference to the flow chart in FIG. 8 and the timing chart in FIG. 9.

After activation the controller 65 of the drive control device 50 (FIG. 5) executes the initialization step S10 and the drive control loop S20 as shown in FIG. 8.

In the initialization step S10 the pulse width T of the drive signal output from the controller 65 to the pulse control circuit 52 is initialized to 0%, and a variable Z0 used by the controller 65 is initialized to the speed setting of 600 rpm read from the storage unit 651.

The drive control loop S20 has a pulse width setting step S21 and a pulse width control step S22 for setting the pulse width of the drive signal based on the speed of the rotor 30. The drive control loop S20 continues until a signal denoting that driving ended is input to the controller 65 (step S100).

In the pulse width setting step S21 the controller 65 sets the pulse width T of the drive signal output to the pulse control circuit 52. Immediately after the piezoelectric actuator 20 starts operating T is the initialized value of 0%, and the pulse width of the drive signal supplied through the pulse control circuit 52 to the piezoelectric actuator 20 is 0%.

If step S100 confirms that driving continues, the pulse width control step S22 executes. The pulse width control step S22 has a speed detection step S221 for detecting the speed of the rotor 30, and a pulse width adjusting step S222 for setting the pulse width of the drive signal based on the rotor 30 speed detected in step S221.

In the speed detection step S221, the speed determined by the speed detection device 71 (FIG. 5) is stored in variable Z1.

In the pulse width adjusting step S222, the speed (Z1) of the rotor 30 acquired by the speed detection step S221 is compared with the speed setting (Z0) set in the initialization step S10. If the detected speed Z1 is greater than the speed setting Z0, step S222A reduces the pulse width T by ΔT (which is 0.1% in this embodiment of the invention). If the detected speed Z1 is less than [or equal to?, sic?] the speed setting Z0, step S222B increases the pulse width T by ΔT (which is 0.1% in this embodiment of the invention).

The pulse width of the drive signal supplied to the piezoelectric actuator 20 is thus controlled by this initialization step S10 and drive control loop S20.

FIG. 9 the waveform of the signals at nodes A to H in FIG. 5. In FIG. 9 signal A denotes the reference pulse width output from the voltage-controlled vibrator (VCO) 51, and the frequency and reference pulse width P of this reference pulse signal A are substantially constant. Signal B in FIG. 9 denotes the output of the speed detection device 71, which represents the rotation of the rotor 30.

Signals C, D, E, F are drive signals that are switched by the switches 551 to 554 driven by the first and second gate drivers 53A and 53B.

Reference pulse signal A is input to the pulse control circuit 52. The pulse control circuit 52 generates a drive signal of pulse width T that is limited by the reference pulse width P, and the on/off states of the switches 551 to 554 are controlled by the waveforms of signals C to F in FIG. 9. More specifically, switches at diagonally opposite corners of the bridge (C and E (E2 and E3 are the same as E) or F and D (D2 and D3 are the same as D) in FIG. 5) switch on/off substantially simultaneously, and by turning the switches alternately on and off, alternating voltage I is supplied with pulse width T to the piezoelectric actuator 20, and expansion and contraction of the piezoelectric elements 22 causes the vibrator 20A to vibrate.

The pulse width of drive signals C to F increases gradually (step S222B) as a result of the pulse width control step S22 (FIG. 8) increasing the pulse width T after starting from the brake period X, which is a non-driven state (brake state), and the rotor 30 therefore begins to turn. After a predetermined time passes the drive state of the piezoelectric actuator 20 enters a steady state Y, and the rotor 30 speed and drive signal pulse width T converge. The pulse duty determined by the pulse width (the HIGH period) of the drive signal at this time is approximately 10%, and this pulse width T is equal to the shortest pulse width corresponding to the slowest rotational velocity (600 rpm) of the rotor 30. That is, the rotor 30 is driven using the minimum torque required to drive the rotor 30 rotationally.

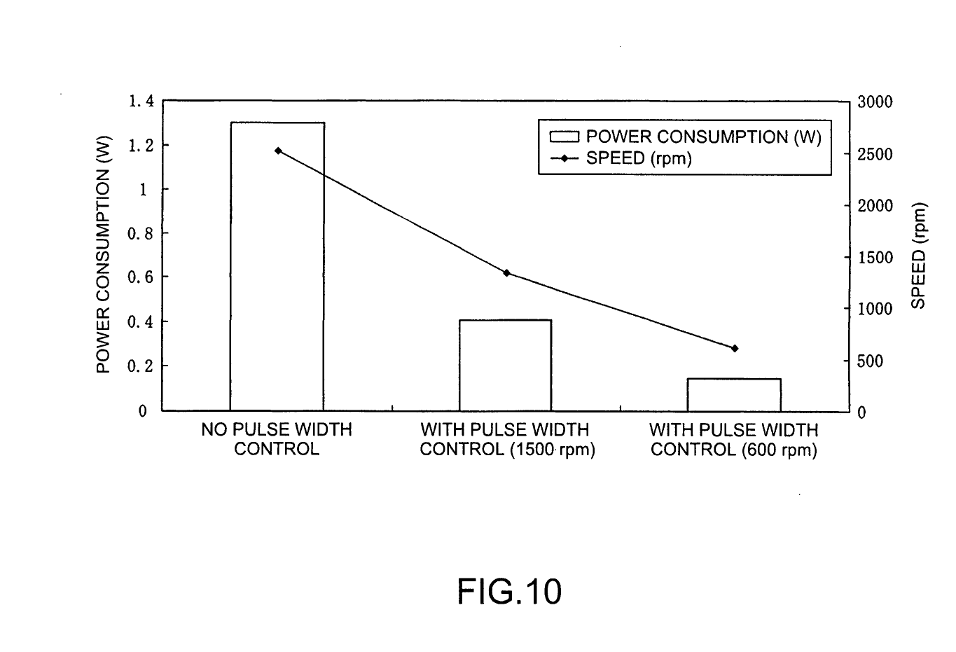

The drive performance of the piezoelectric actuator 20 controlled by the drive control device 50 is shown in the graph in FIG. 10. FIG. 10 shows the change in the rotor 30 speed and power consumption by the piezoelectric actuator 20 and drive control device 50 relative to the pulse width T of the drive signal.

More specifically, the graph shows the change when the drive signal pulse width T is not restricted by the reference pulse width P and has a pulse duty ratio of 100%, when the pulse width T is limited by the steps shown in FIG. 8 using the speed setting of 1500 rpm stored in the storage unit 651, and when the pulse width T is limited using a speed setting of 600 rpm as in this embodiment of the invention. When the speed setting is 1500 rpm, the drive signal pulse duty is approximately 30%, and when the speed setting is 600 rpm, the drive signal pulse duty is approximately 10% as described above.

As will be known from piezoelectric actuator unit 10, power consumption is clearly less when the drive signal pulse width T is limited than when the pulse width is not limited.

### 7. Effects of this Embodiment of the Invention

This embodiment of the invention affords the following effects.
1) By limiting the pulse width T of the drive signal based on a reference pulse width P to a pulse width that can just drive the rotor 30, the drive control device 50 of the piezoelectric actuator 20 for driving the date display device 90 can reduce the pulse duty of a rectangular wave drive pulse signal. Output can therefore be reduced to the level that can drive the rotor 30 by limiting the pulse width T of the drive signal even when the specified output of the piezoelectric actuator 20 is set to a relatively high level in order to sufficiently exceed the required torque when the drive signal pulse width T is 100% of the reference pulse width P (100% pulse duty). Power consumption can therefore be reduced greatly below the power consumption level at a 100% pulse duty when the drive signal pulse width is not limited.
2) Piezoelectric actuator 20 output when driving the rotor 30 can also be reduced as much as possible as a result of determining the minimum speed at which the rotor 30 turns when the rotor 30 is driven with the lowest torque required to drive the rotor 30 and controlling drive so that the rotor 30 speed is held near this minimum speed. More particularly, power consumption by the piezoelectric actuator 20 and drive control device 50 can also be held to the minimum.
(3) The drive control device 50 has a speed detection device 71, the speed detection device 71 detects the speed of the rotor 30 in the drive control loop S20, and the drive signal pulse width is set based on the detected rotor speed. The desired drive power can therefore be reliably achieved and the rotor 30 can be driven steadily even if, for example, the pressure between the piezoelectric actuator 20 and the rotor varies due to piezoelectric actuator 20 wear.
(4) Incorporating this drive control device 50 in a electronic timepiece 1 that operates with a battery 91 can extend the life of the battery 91. The battery is therefore replaced less frequently, and timepiece maintenance requirements are improved.
(5) Because the piezoelectric actuator 20 drives the rotor 30 simply with the least possible power consumption, the piezoelectric actuator 20 can be used to great effect when the piezoelectric actuator 20 is used in the date display device 90, which does not require precise drive speed control.

Variations of the above first embodiment are described below.

Variation 1 of the First Embodiment

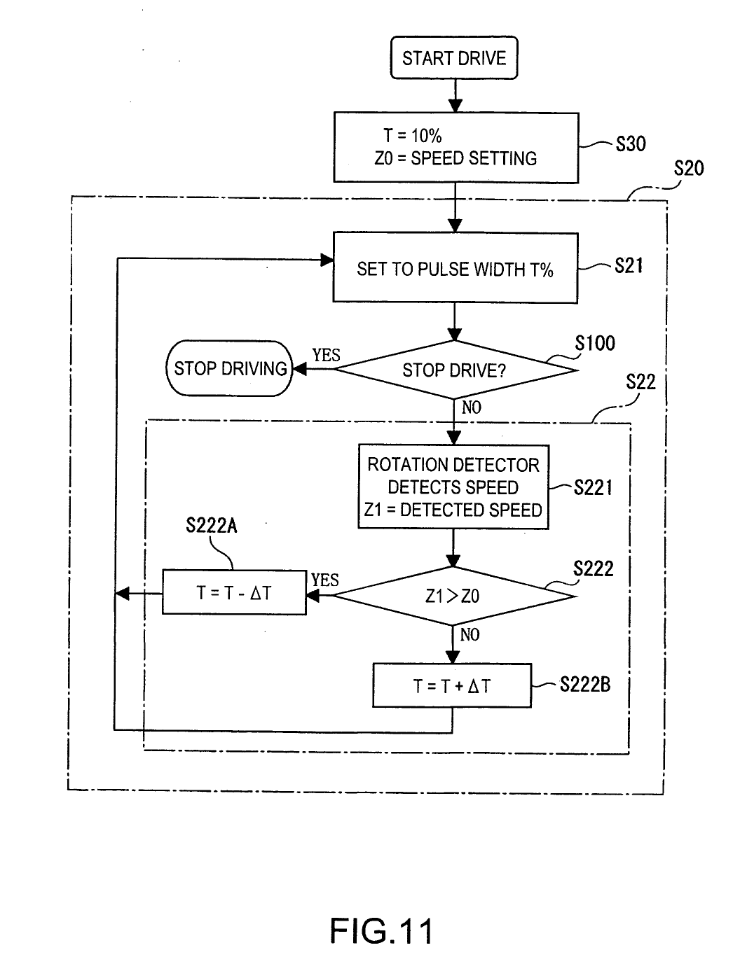

The initialization step S10 described above initializes the pulse width T of the drive signal output from the controller 65 to the pulse control circuit 52 to 0%, but the initial pulse width T is not so limited and can be set as desired. As shown in FIG. 11, for example, the pulse width T can be initialized to 10% as the appropriate pulse width, and the drive signal pulse width can be adjusted in the drive control loop S20 until operation stabilizes at the rotor 30 speed setting. In this case a drive signal with a 10% pulse width duty corresponds to the minimum rotor 30 speed of 600 rpm (FIG. 7), the rotor 30 therefore reaches a steady state more quickly, and the piezoelectric actuator 20 startup time is shortened. Power consumption can therefore be sufficiently reduced without sacrificing startup speed. The initial pulse width of the drive signal is not limited to 10% of the appropriate pulse width, and can be set to 5% or other pulse width that is less than the appropriate pulse width and the pulse duty can be gradually increased according to the detected speed.

Variation 2 of the First Embodiment

In the first variation of the first embodiment described above the appropriate pulse width (such as 10%) can be stored in the storage unit 651 and the appropriate pulse width stored in the storage unit 651 can be updated when operation stabilizes after startup. More specifically, by updating the appropriate pulse width each time operation starts, the pulse width at which the rotor 30 stabilizes while driving after the last startup is saved as the appropriate pulse width for the next time rotor 30 drive starts, and drive power and power consumption can therefore be optimized.

Alternatively, instead of saving the pulse width from just the previous startup operation, the pulse widths of the plural drive signals used to drive the rotor 30 in a steady state following a plurality of startup operations can be accumulated as the appropriate pulse width in the storage unit 651. The average pulse width of plural operations can then be used to optimize the appropriate pulse width and further optimize the drive power and power consumption.

Variation 3 of the First Embodiment

Further alternatively, the initialization step S00 executed when drive control starts can be configured to sweep the drive signal pulse width to determine the lowest speed that achieves the lowest torque that can drive the rotor 30. Because drive control is based on the lowest speed determined in the initialization step S00, the torque required to turn the rotor 30 can be reliably determined.

Variation 4 of the First Embodiment

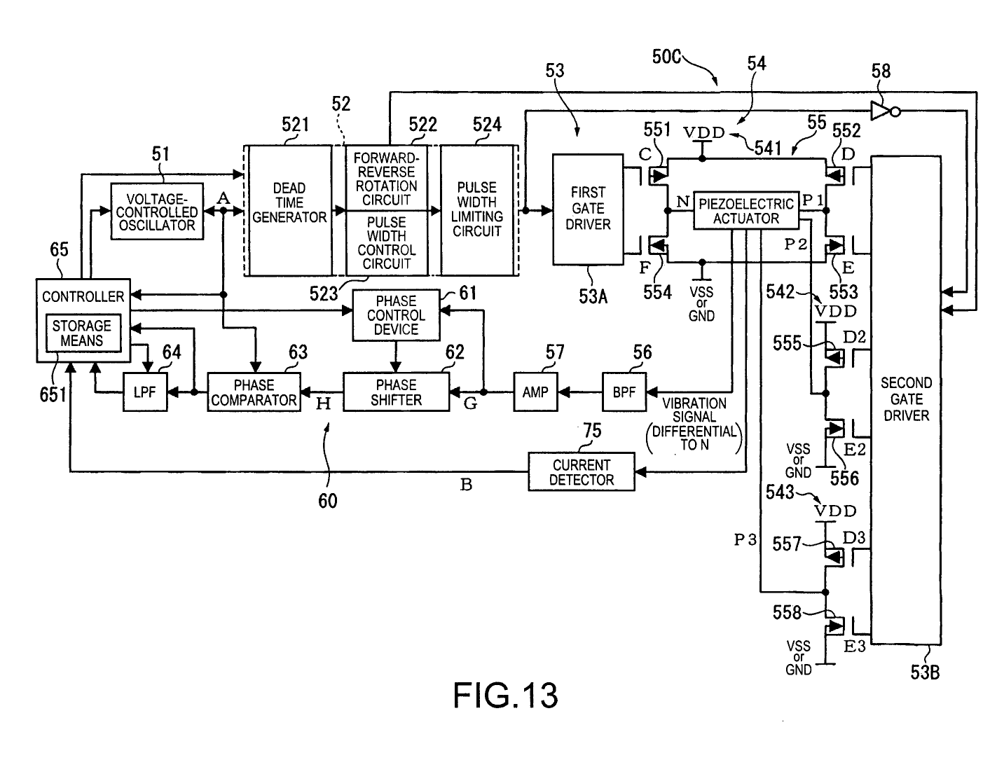

The above embodiment detects the rotor 30 speed and controls drive by comparing the detected speed with the minimum speed, for example. Drive control can alternatively be based on the piezoelectric actuator 20 current instead of the rotor 30 speed. In this case, as shown in FIG. 13, the drive control device 50A has a current detector 75 for detecting current flow through the piezoelectric actuator 20, and the minimum current level that can drive the rotor 30 is stored in the storage unit 651 of the controller 65. In the drive control loop S20 this minimum current level is compared with the current detected by the current detector 75 for drive control. This aspect of the invention achieves the same effects described above.

Variation 5 of the First Embodiment

The value denoting the predetermined drive power used for drive control is set to a minimum speed of 600 rpm above, but the invention is not so limited and the specified speed (the speed setting in the above embodiment) can be set to 1000 rpm for drive control. In this case the drive signal pulse duty is approximately 25%, and the rotor 30 turns at approximately 1000 rpm.

It will thus be obvious that the present invention limits the drive signal pulse width relative to a reference pulse width to a level that can drive the driven body.

### Second Embodiment

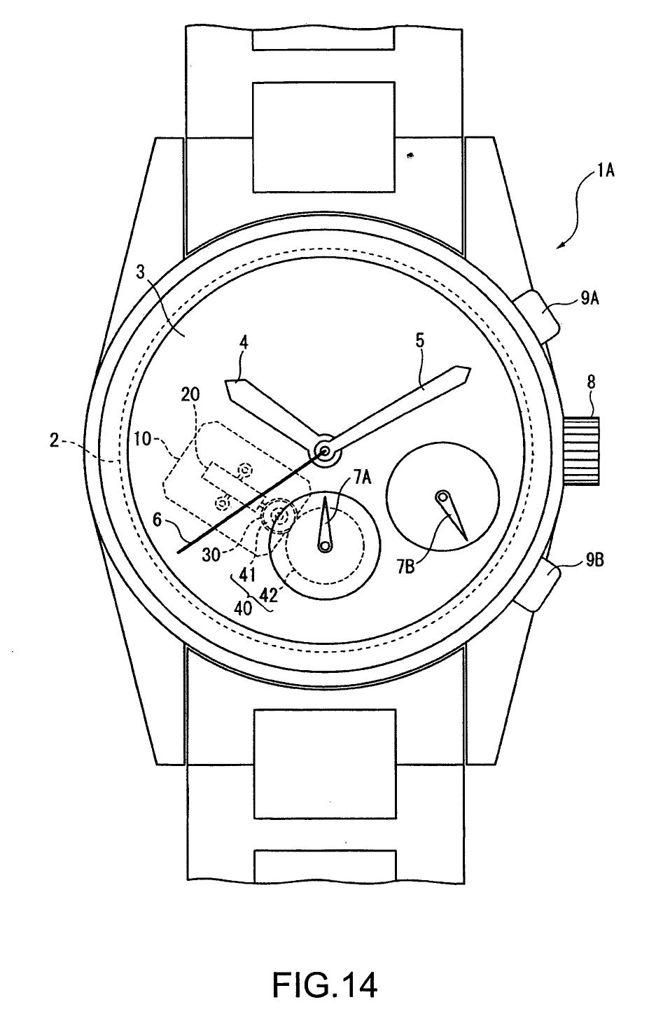

A second embodiment of the invention is described below with reference to FIG. 14 to FIG. 25. Similarly to the first above first embodiment, this aspect of the invention also controls driving a piezoelectric actuator 20, and the piezoelectric actuator drive control device and method of this aspect of the invention include the piezoelectric actuator drive control device and method of the first embodiment. This aspect of the invention additionally enables drive stability with phase difference feedback control by implementing steps specific to this embodiment.

### 2-1 Arrangement of the Electronic Timepiece

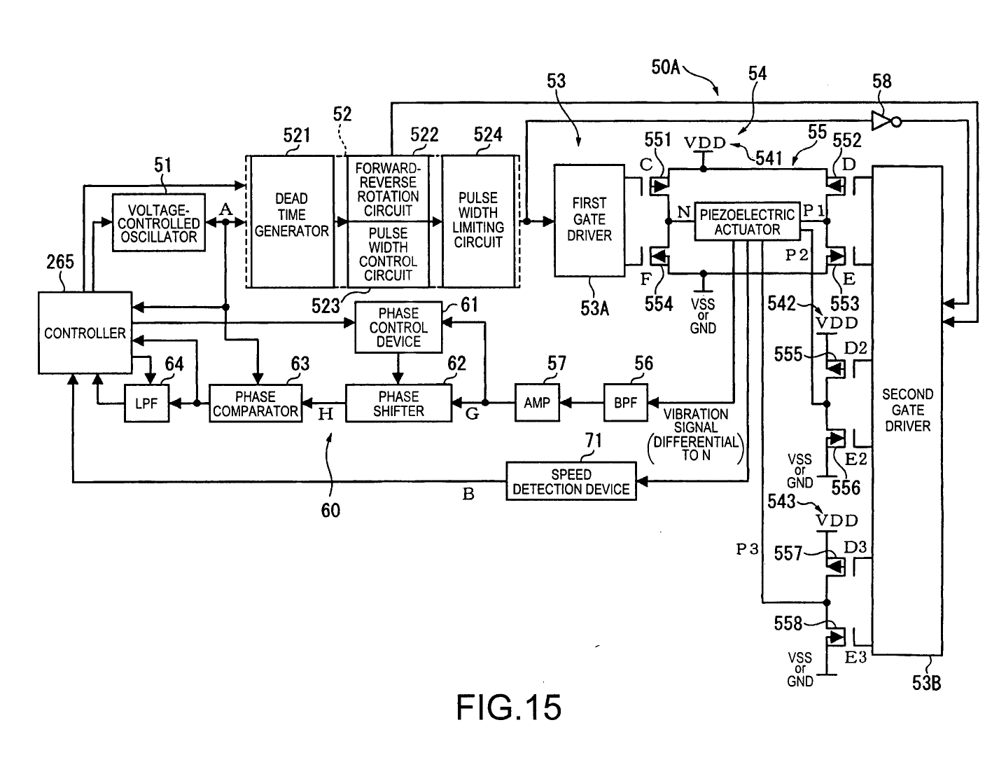

FIG. 15 is a plan view of an electronic timepiece 1A according to this embodiment of the invention. The electronic timepiece 1A is a timekeeping device rendered as a wristwatch that has a movement 2 as the timekeeping unit, and a dial 3, hour hand 4, minute hand 5, second hand 6 as a time display unit for displaying the normal time, and a chronograph second hand 7A and chronograph minute hand 7B for displaying chronograph time. A crown 8, and chronograph operating buttons 9A and 9B disposed on opposite sides of the crown 8, are also disposed in the case of the electronic timepiece 1A.

The piezoelectric actuator unit 10 described in the first embodiment (FIG. 2, FIG. 3) is used as the drive mechanism for driving the chronograph second hand 7A in this embodiment of the invention.

### 2-2 Arrangement of the Piezoelectric Actuator Drive Device

FIG. 15 shows the arrangement of the drive control device 50A for a piezoelectric actuator according to this embodiment of the invention.

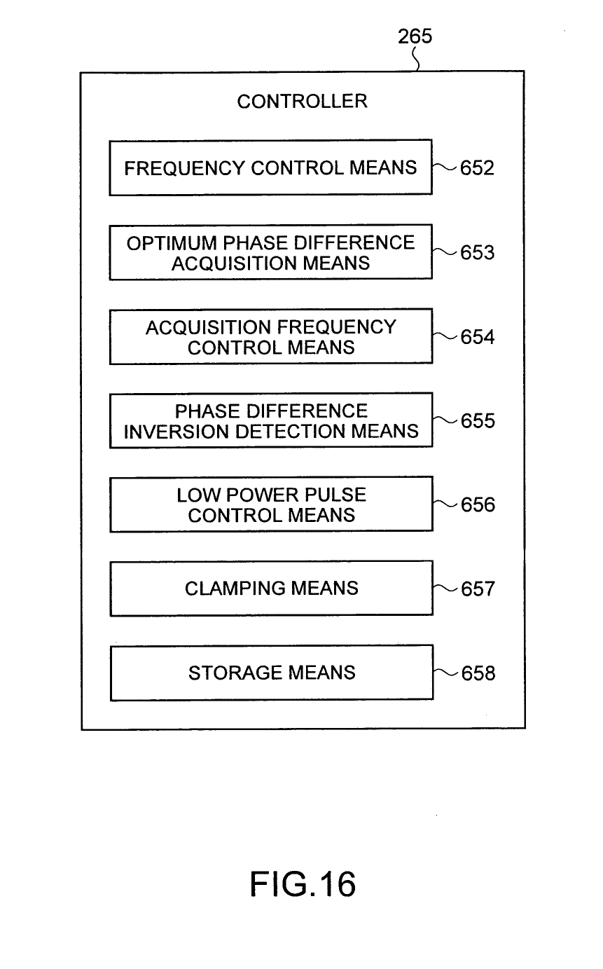

FIG. 16 is a block diagram of the controller 265. The controller 265 includes a frequency control unit 652 for causing the frequency of the drive signal to track the phase difference fed back through the phase difference detection unit 60; an optimum phase difference acquisition unit 653 for determining the optimum phase difference that achieves the predetermined drive state; an acquisition frequency control unit 654 for controlling how frequently the optimum phase difference is determined, a phase difference inversion detection unit 655 for detecting if the phase difference between the phase of the drive signal and the phase of the detection signal equals the value of the target phase difference a plurality of times when sweeping the drive frequency, a low power pulse control unit 656 (control unit) for outputting a control value limiting the drive signal pulse width to the pulse control circuit 52; a clamping unit 657 for limiting the drive frequency, and a storage unit 658. The optimum phase difference acquisition unit 653 and the phase difference inversion detection unit 655 render an initialization unit.

The frequency control unit 652 in the controller 265 functions as a unit for tracking the frequency of the drive signal to the phase difference fed back through the phase difference detection unit 60, and outputs a voltage signal to the voltage controlled vibrator 51 in order to eliminate deviation to the input target phase difference.

The optimum phase difference acquisition unit 653 determines the optimum phase difference at the specific frequency determined by the acquisition frequency control unit 654, and this frequency is determined by the continuous drive time since the piezoelectric actuator 20 is activated by operating the operating button 9A (FIG. 16 [FIG. 1, sic] ). The acquisition frequency is one hour of continuous driving in this embodiment of the invention, and is stored in storage unit 658.

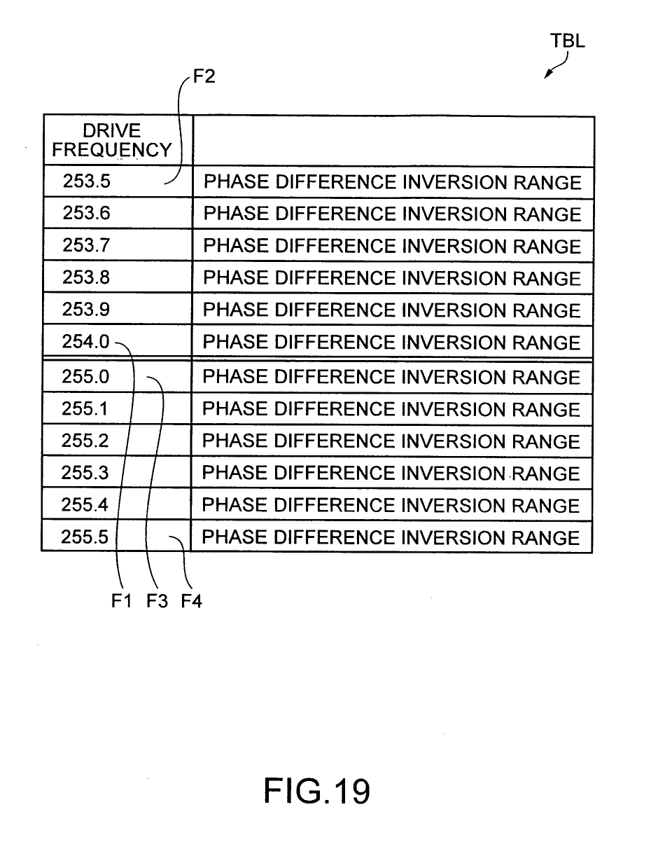

In addition to the continuous drive time referenced by the acquisition frequency control unit 654, the storage unit 658 also stores a data table TBL of drive frequencies (FIG. 19) and the speed setting (1500 rpm) denoting the torque (drive power) required to drive the rotor 30 with substantially greatest efficiency.

When the frequency of the drive signal supplied to the vibrator 20A is swept and the target phase difference is detected again, the clamping frequency where the phase difference reverses is stored in the data table TBL (FIG. 19) stored in the storage unit 658.

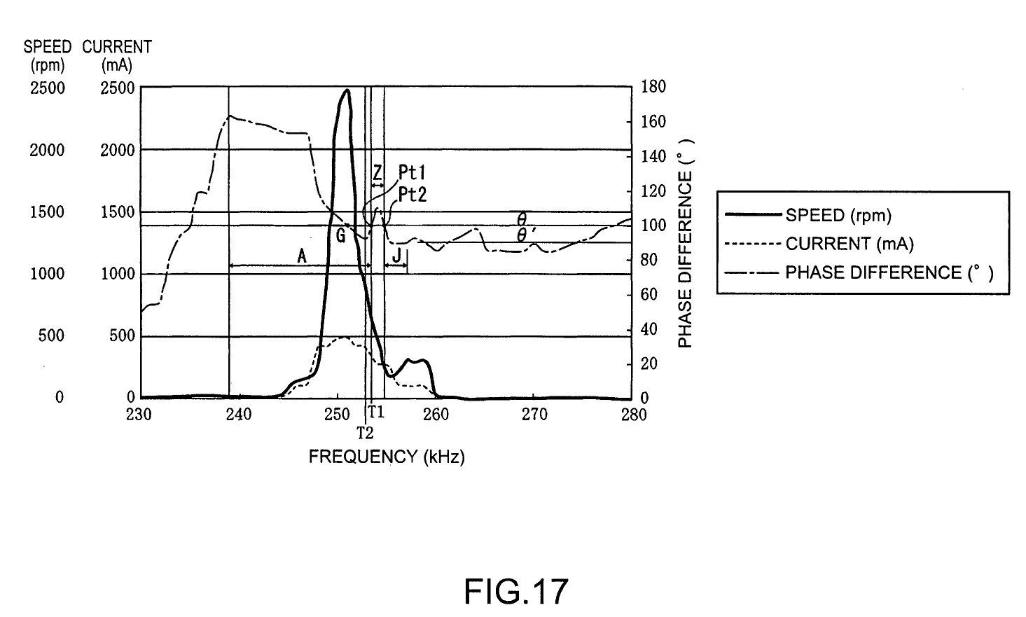

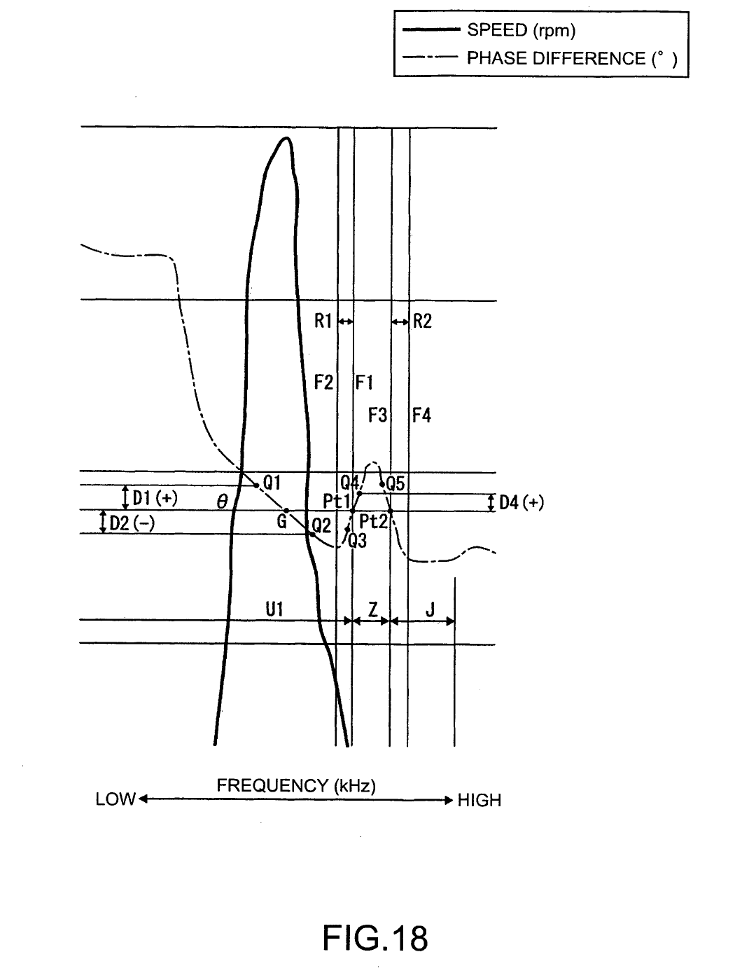

FIG. 17 is a graph showing the phase difference of the vibrator 20A, the speed of the rotor 30, and the current flow through the piezoelectric actuator 20 when sweeping the drive signal frequency. FIG. 18 is an enlargement of part of FIG. 17. Note that the values and the slope of the rise and fall may vary due to individual differences in the vibrator 20A.

The phase difference between the drive signal and detection signal is indicative of the vibration characteristic of the vibrator 20A, and in this embodiment of the invention the phase difference in the optimum drive state (specified drive state) G achieving substantially the maximum rotor 30 speed is target phase difference θ (approximately 100 degrees in this embodiment of the invention). When the phase difference is target phase difference θ, the piezoelectric actuator 20 can be driven at maximum efficiency by the resonance of longitudinal vibration and the resonance of sinusoidal vibration in the vibrator 20A.

A drive range UI in which the vibration characteristic is stable and the slope of the rise or fall in the phase difference during the drive frequency sweep is in one direction only, and which includes the optimum drive state G, is set in the drive control device 50 for phase difference feedback control. In this drive range UI the phase difference drops when the drive frequency increases, and the tracking direction of the drive frequency based on the size of the phase difference to the target phase difference θ does not reverse.

Due to alignment error in the piezoelectric elements 22 and reinforcing plate 21 of the vibrator 20A, and overlap in the phase of longitudinal vibration and the phase of sinusoidal vibration as a result of driving the vibrator 20A by supplying a single drive signal, the phase difference may increase and reach the target phase difference θ again (at inversion point Pt1) after the phase difference decreases from the target phase difference θ in drive range UI when sweeping the drive frequency from the low frequency side to the high frequency side. At this inversion point Pt1 the phase difference is increasing, which is opposite the slope of the phase difference at optimum drive state G (that is, decreasing). The period from this inversion point Pt1 to return point Pt2, where the phase difference reaches the target phase difference θ again and the slope of the rise or fall in the phase difference has returned to the same slope as before the phase difference inversion, is phase difference inversion range Z wherein phase difference feedback control is unstable.

As shown in FIG. 18, on opposite sides of phase difference inversion range Z are phase difference inversion range R1 that is −0.5 kHz wide from the phase difference inversion frequency F1 at inversion point Pt1, and phase difference return range R2 that is +0.5 kHz wide from return frequency F3 at phase return point Pt2. The limits of phase difference inversion range R1 are therefore phase difference inversion frequency F1 and clamping frequency F2, which is phase difference inversion frequency F1 minus 0.5 kHz, and the limits of phase difference return range R2 are return frequency F3 and return clamping frequency F4, which is return frequency F3 plus 0.5 kHz.

The frequencies in phase difference inversion range R1 and phase difference return range R2 including phase difference inversion frequency F1, clamping frequency F2, return frequency F3, and return clamping frequency F4 are stored in a table in the storage unit 658.

FIG. 19 shows the content of the data table TBL stored in the storage unit 658. The storage unit 658 stores the frequencies in phase difference inversion range R1 and phase difference return range R2 as data table TBL.

### 2-3 Drive Control of the Piezoelectric Actuator

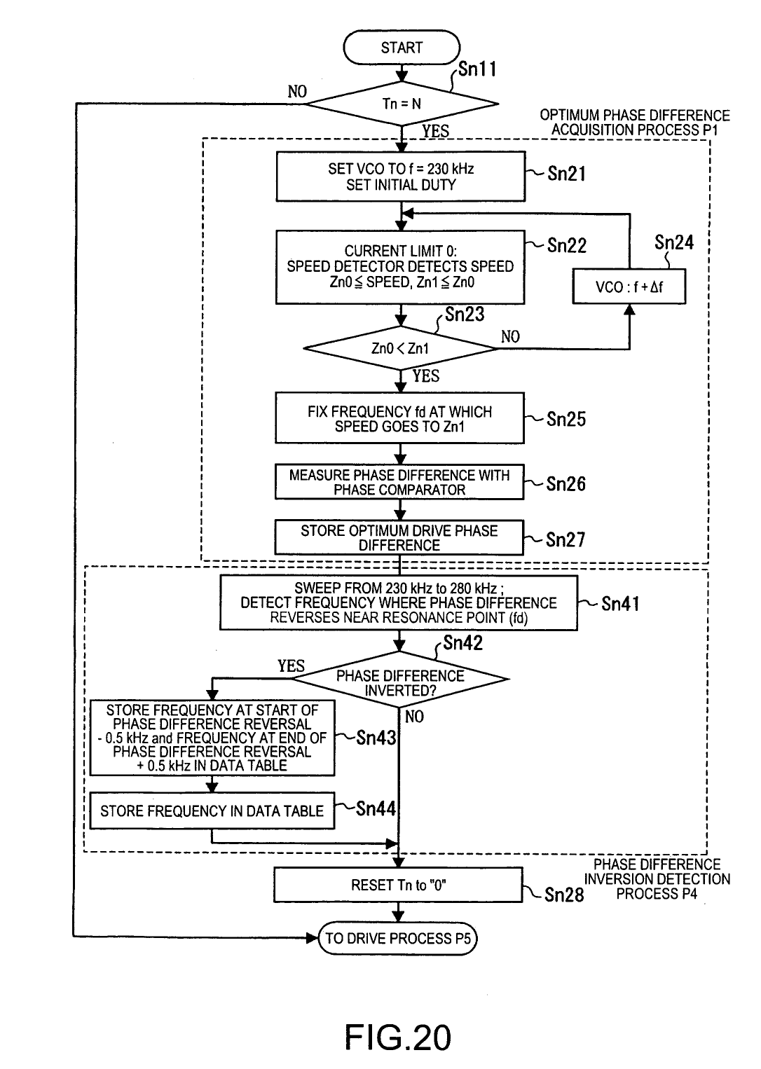

Drive control of the piezoelectric actuator 20 by the drive control device 50A is described next with reference to the flow charts in FIG. 20 to FIG. 22.

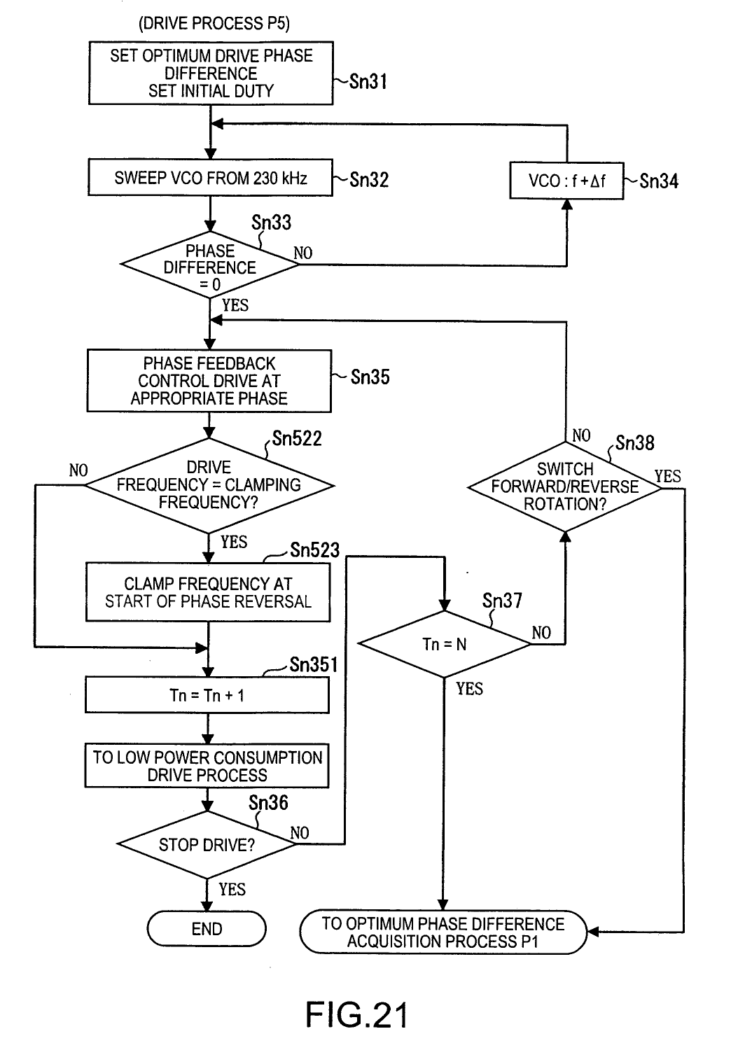

The controller 265 of the drive control device 50A executes the optimum phase difference acquisition process P1 and the phase difference inversion detection process P4 shown in FIG. 20, and the drive process P5 shown in FIG. 21.

Note that the optimum phase difference acquisition process P1 and phase difference inversion detection process P4 together render an initialization process.

### 2-3-1 Operation of the Acquisition Frequency Control Unit

Referring to FIG. 20, the controller 265 checks the elapsed time Tn since piezoelectric actuator 20 operation started, that is, the continuous drive time, using the timer function of the acquisition frequency control unit 654 (step Sn11) to execute the optimum phase difference acquisition process P1 and phase difference inversion detection process P4. More specifically, if confirmation of the continuous drive time (step Sn11) determines that the elapsed time Tn since the piezoelectric actuator 20 started operating has reached the continuous drive time N stored in the storage unit 658 of the controller 265 (step Sn11 returns Yes), the optimum phase difference acquisition process P1 is executed. If not (step Sn11 returns No), the drive process P5 described in FIG. 21 is executed.

When piezoelectric actuator 20 operation starts, the elapsed time Tn is initialized to 0.

### 2-3-2 Optimum Phase Difference Acquisition Process

In the optimum phase difference acquisition process P1 the optimum phase difference acquisition unit 653 of the controller 265 finds the desired piezoelectric actuator 20 drive state for driving the 30, which in this embodiment of the invention is defined as operating at substantially maximum efficiency (maximum rotor 30 speed).

More specifically, the frequency of the drive signal produced by the voltage controlled vibrator 51 is first set to a low frequency (230 kHz in this embodiment of the invention) and the initial pulse width (duty) of the drive signal is set (step Sn21). This initial duty rate is set between 50% and 95%, for example.

The speed of the rotor 30 is then detected based on the speed input from the rotation sensor 15 (FIG. 2) with no current limiting (step Sn22). Two variables Z0 and Z1 are used to detect the rotational speed. Each time the speed is detected, the current speed is stored to Z0, and Z0 and Z1 are compared. If Z0 is greater than Z1, Z0 is stored to Z1. The speed that is provisionally the maximum rotational speed each time the drive frequency is swept is thus continuously substituted for Z1 and Z1 is thus updated.

Z0 and Z1 are then compared Z0 (step Sn23), and if Z0 (the currently detected speed) is less than or equal to Z1 (the value provisionally stored as the maximum rotational speed) (step Sn23 returns No), the peak speed has still not been detected. The drive frequency is therefore increased a predetermined amount (step Sn24), and sweeping continues. In this embodiment of the invention the drive frequency is increased in 0.5 kHz increments and the drive frequency is swept in one direction from 230 kHz to 280 kHz. It will be obvious that in this and the following embodiments of the invention the drive frequency can alternatively be swept from high frequency to low frequency.

If Z0 is less than Z1 (step Sn23 returns Yes), rotor speed is considered to have passed the peak speed. The value of Z1 provisionally stored based on the data from the previous detection instance is therefore set as the frequency denoting the maximum rotor speed (maximum drive efficiency), and control goes to step Sn25.

The speed is then fixed to the frequency fd at which the rotor speed equals Z1 (step Sn25), and the phase comparator 63 then detects the phase difference in this state (step Sn26). The phase difference detected by the phase comparator 63 is set as the optimum phase difference and stored in the storage unit 658 of the controller 265 (step Sn27).

The phase difference inversion detection process P4 is then executed based on this stored optimum phase difference.

The phase difference inversion detection process P4 determines if phase difference inversion occurs, that is, whether the size of the phase difference reverses when the optimum phase difference (see θ in FIG. 17 and FIG. 18) is achieved again when sweeping the drive frequency (steps Sn41, Sn42). This optimum phase difference θ is set in the phase shifter 62.

More specifically, the phase difference inversion detection unit 655 of the controller 265 applies phase difference feedback control using the phase difference detection unit 60 while sweeping the frequency of the drive signal output by the voltage controlled vibrator 51 in one direction from 230 kHz to 280 kHz in steps Sn41 and Sn42.

If this phase difference inversion results as described in FIG. 17, the phase difference inversion detection result of the clamping unit 657 is YES, the data table TBL (FIG. 19) is compiled (Sn43), and the data table TBL is stored in the storage unit 658 (Sn44).

If phase difference inversion does not occur, the phase difference inversion detection result is NO, and data in the data table TBL stored in the storage unit 658 is deleted in this embodiment of the invention.

When the optimum phase difference acquisition process P1 and phase difference inversion detection process P4 end, the elapsed time Tn is reset to 0 (step Sn28), and control goes to the drive process P5.

### 2-3-3 Drive Step

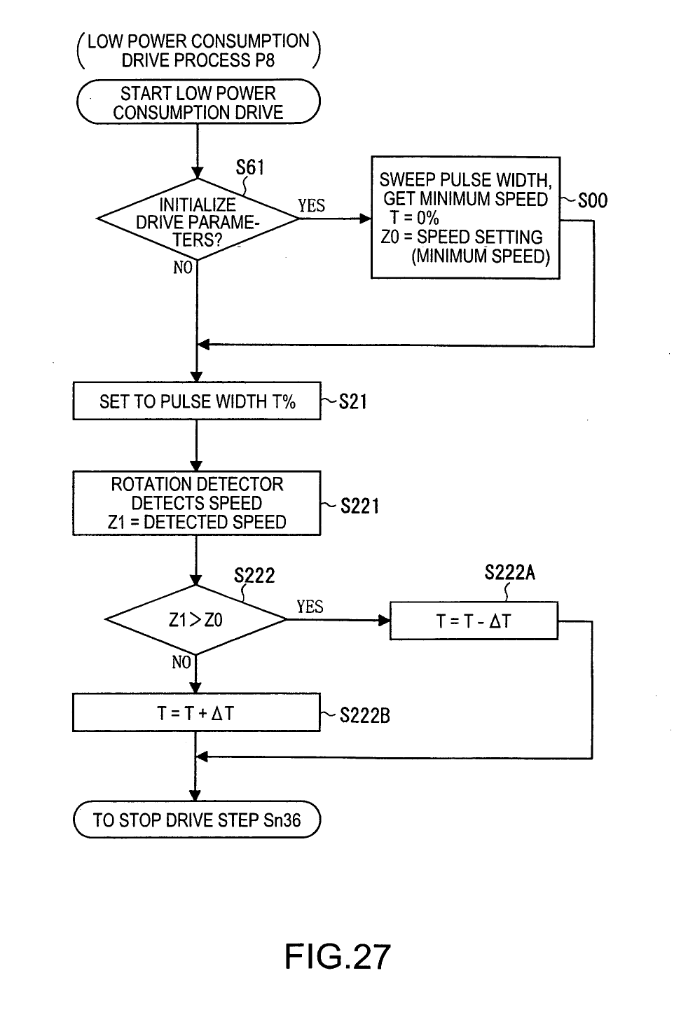

In the drive process P5 shown in FIG. 21 the controller 265 first sets the phase shifter 62 to the optimum phase difference stored in the storage unit 658 in the optimum phase difference acquisition process P1 (FIG. 27), and then initializes the drive signal pulse width (duty) (step Sn31). Note that the initial duty is set to approximately 50% to 95%, for example. The drive frequency is then swept from 230 kHz (step Sn32) and phase difference feedback control is applied by the phase difference detection unit 60 and frequency control unit 652 (FIG. 16). More specifically, the drive frequency is swept using the same frequency increment described above until the phase difference output from the phase comparator 63 goes to 0, that is, until the detected phase difference matches the optimum phase difference set in the phase shifter 62 (steps Sn33 and Sn34).

If the phase difference matches the optimum phase difference (step Sn33 returns Yes), phase difference feedback control using the phase difference detection unit 60 continues in the same way, thereby causing the frequency of the drive signal to track the phase difference between the detection signal and the drive signal (step Sn35). More specifically, the frequency control unit 652 controls the voltage signal input to the voltage controlled vibrator 51 so that the phase difference equals the optimum phase difference and output from the phase comparator 63 is therefore zero. When producing and outputting this voltage signal to the voltage-controlled vibrator 51, whether the drive frequency denoted by the voltage signal to be generated matches a frequency in the data table TBL (FIG. 19) is determined (Sn522).

If the drive frequency indicated by the voltage signal to be generated does not match a frequency in the data table TBL (Sn522 returns No), the voltage signal is generated and output to the voltage controlled vibrator 51, thus changing the frequency of the drive signal output by the voltage controlled vibrator 51.

More specifically, when the drive state is Q1 (FIG. 18), there is a large positive deviation D1 (FIG. 18) between the detected phase difference and the optimum phase difference (θ in FIG. 18), and the drive frequency is therefore increased in order to reduce the phase difference. If the drive state is Q2, there is a small negative deviation D2 (FIG. 18) between the phase difference and the optimum phase difference (θ), and the drive frequency is therefore decreased in order to increase the phase difference.

Steps Sn521 and Sn522 repeat as long as the drive frequency denoted by the voltage signal generated by the controller 265 does not match a frequency in the data table TBL.

If phase difference inversion is not detected in the previously executed phase difference inversion detection process P4, this embodiment of the invention controls the generated voltage signal generated by the controller 265 each time a detection signal is input without determining whether the drive frequency denoted by the voltage signal matches a frequency in the data table TBL (Sn522).

However, if the voltage signal to be generated by the controller 265 matches a frequency in the data table TBL (FIG. 19) (Sn522 returns Yes), the frequency at the start of the phase difference inversion is clamped to generate and output the voltage signal (Sn523).

This holds the frequency of the drive signal generated by the voltage controlled vibrator 51 and limits tracking the drive frequency to the phase difference, and therefore prevents the drive frequency from passing clamping frequency F2 and reaching the phase difference inversion frequency F1, and thus prevents the tracking direction of the drive frequency from reversing based on the phase difference.

If tracking the drive frequency to the phase difference is not limited, the drive state of the piezoelectric actuator 20 may pass drive state Q3 in the phase difference inversion range R1 and reach drive state Q4. In this case, while the drive frequency must decrease from drive state Q4 in order to return to the optimum drive state G, the drive frequency is increased in order to reduce the phase difference because the phase difference is greater than the target phase difference θ.

More specifically, because the tracking direction of the drive frequency based on whether the phase difference is greater or less than the target phase difference θ reverses before and after inversion point Pt1, the drive frequency is adjusted in the direction opposite the appropriate direction, and the drive state goes from drive state Q4 to drive state Q5, that is, to a drive state away from the optimum drive state G. The slope of the change in the phase difference reverses between drive state Q4 and drive state Q5, the drive frequency is changed by phase difference feedback control before and after return point Pt2 where the phase difference is equal to the target phase difference θ, and it is substantially impossible to return the drive state of the piezoelectric actuator 20 to near the optimum drive state G even though the drive state of the piezoelectric actuator 20 is far from the optimum drive state G.

Tracking the drive frequency to the phase difference is therefore limited as described above in order to prevent this problem.

Feedback control when the size of the phase difference inverts can be reliably prevented by setting a clamping frequency F2 separated from the phase difference inversion frequency F1 by a frequency width (0.5 kHz) greater than the variation in the drive frequency caused by phase difference tracking or a temperature change, and preventing the drive frequency from reaching this clamping frequency F2 as described above.

After clamping (Sn523), control returns to step Sn521 to repeat the process using the next detection signal, and track the drive signal frequency to the phase difference if step Sn522 returns NO.

The drive frequency can therefore track the phase difference instead of being fixed in order to handle changes in the vibration characteristic of the vibrator 20A caused by temperature change, for example, and if the size of the phase difference changes, driving the piezoelectric actuator 20 can be stably controlled without erroneously adjusting the drive frequency in the wrong direction.

Frequency data in the phase difference return range R2 is stored in the data table TBL (FIG. 19) in the storage unit 658 in addition to frequency data in the phase difference inversion range R1, and the values for the phase difference return range R2 are used as described below.

If it is necessary to shift driving to a drive range J (FIG. 17) on the high frequency side of return point Pt2 when the voltage signal output of the controller 265 is clamped by referencing clamping frequency F2, a frequency in phase difference return range R2 is preferably referenced to limit the drive frequency so that the drive state does not become unstable. More specifically, before actually changing the drive frequency the process causing the drive frequency to track the phase difference determines if the frequency to which the drive frequency is to be changed matches a value in the phase difference return range R2, and if a match is confirmed clamps that frequency in order to hold the drive frequency.

Stable drive control can thus be sustained outside of the phase difference inversion range Z where drive control is unstable.

Furthermore, there is also an optimum drive state on the high frequency side of the return point Pt2, and when the piezoelectric actuator 20 must be driven in drive range J, the drive frequency can be limited by referencing the frequencies in the phase difference return range R2.

If the phase difference repeatedly increases and decreases and the slope of change in the phase difference is not constant when sweeping the drive frequency as shown in FIG. 17, evaluation of the phase difference relative to the set target phase difference (θ′ in FIG. 17, for example) may invert in more than one place

In this situation the drive frequencies in the phase difference inversion range and phase difference return range at each inversion location can also be added to the data table TBL (FIG. 19) for drive control.

The drive control device 50 can thus control driving the piezoelectric actuator 20 in all drive frequency ranges swept from 230 kHz to 280 kHz except in the ranges where the phase difference inverts.

After clamping (Sn523), control returns to step Sn35 and processing continues using the next detection signal. If step Sn522 then returns No, the drive signal frequency tracks the phase difference.

Each time the phase difference feedback steps Sn35, Sn522 and Sn523 execute, the drive time counter variable denoting the elapsed time Tn is incremented 1 in the controller 265 (step Sn351).

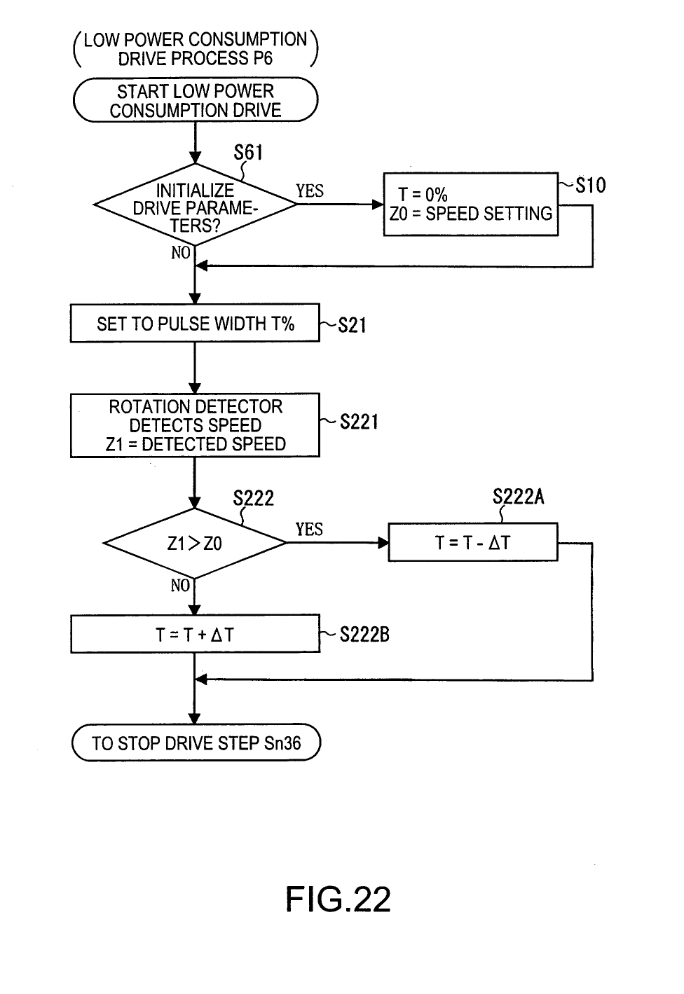

The low power consumption drive process P6 shown in FIG. 22 then executes in the next step Sn39. This low power consumption drive process P6 is incorporated in the phase difference feedback control loop (Sn35, Sn522, Sn523, Sn351, Sn36, Sn37, Sn38) of the drive process P5 (FIG. 21), and the process executed in the low power consumption drive process P6 corresponds to the process of the first embodiment shown in FIG. 8. The operations of the low power consumption drive process P6 are executed by the low power pulse control unit 656 (FIG. 16).

The first step in the low power consumption drive process P6 is to determine if the drive parameters required for the low power consumption drive process P6 need initializing (S61). If initialization is required (Yes), the pulse width T of the drive signal output from the controller 265 to the pulse control circuit 52 is initialized to 0%, and a variable Z0 used by the controller 265 is initialized to the speed setting of 1500 rpm read from the storage unit 658. If step S61 returns Yes, the low power consumption drive process P6 is usually called for the first time after the piezoelectric actuator 20 starts operating (the start of the flow chart in FIG. 20).

After step S61, the pulse width setting step S21 and the pulse width control step S22 for setting the drive signal pulse width based on the rotor 30 speed execute based on the initialized drive parameters as described in the flow chart in FIG. 8.

By controlling the pulse width of the drive signals supplied to the piezoelectric actuator 20, this low power consumption drive process P6 results in the same signal waveforms at nodes A to H of the drive control device 50A as shown in FIG. 9.

More specifically, the pulse widths of drive signals C to F increase gradually (step S222B) as a result of increasing pulse width T in the pulse width control step S22 (FIG. 22) after starting from the brake period X, which is a non-drive period (a brake is applied), and the rotor 30 therefore starts to turn. After a predetermined time passes, the drive state of the piezoelectric actuator 20 enters a steady state, and the rotor 30 speed and drive signal pulse width T converge. The pulse duty determined by the drive signal pulse width (HIGH portion) at this time is approximately 30%, and this pulse width T corresponds to the rotor 30 speed (1500 rpm) as shown in FIG. 7.

The drive performance of a piezoelectric actuator 20 that is controlled using this low power consumption drive process P6 is the same as shown by the graph in FIG. 10, and when the drive signal pulse width T is limited as described in this aspect of the invention, power consumption can be reduced compared with not limiting the pulse width.

Control by the low power pulse control unit 656 ends after all steps in the low power consumption drive process P6 end, and control returns to step Sn36 in the drive process P5 shown in FIG. 21.

Phase difference feedback control in the drive process PS continues until a signal is input to the controller 265 to stop driving (step Sn36), or until a signal for changing the direction of chronograph second hand 7A rotation is input to the controller 265 (step Sn38).

Phase difference feedback control based on the phase difference between the drive signal and detection signal (the optimum phase difference) is used to control driving the piezoelectric actuator 20 in this embodiment of the invention, but the vibration characteristic of the piezoelectric actuator 20 can change over time due to heat or wear from continuously driving the piezoelectric actuator 20. This changes the optimum phase difference that should be used as the target for control by the drive control device 50A, and can result in the desired torque not being achieved.

Such changes over time also change the phase difference inversion frequency F1 and clamping frequency F2, and therefore affect drive control.

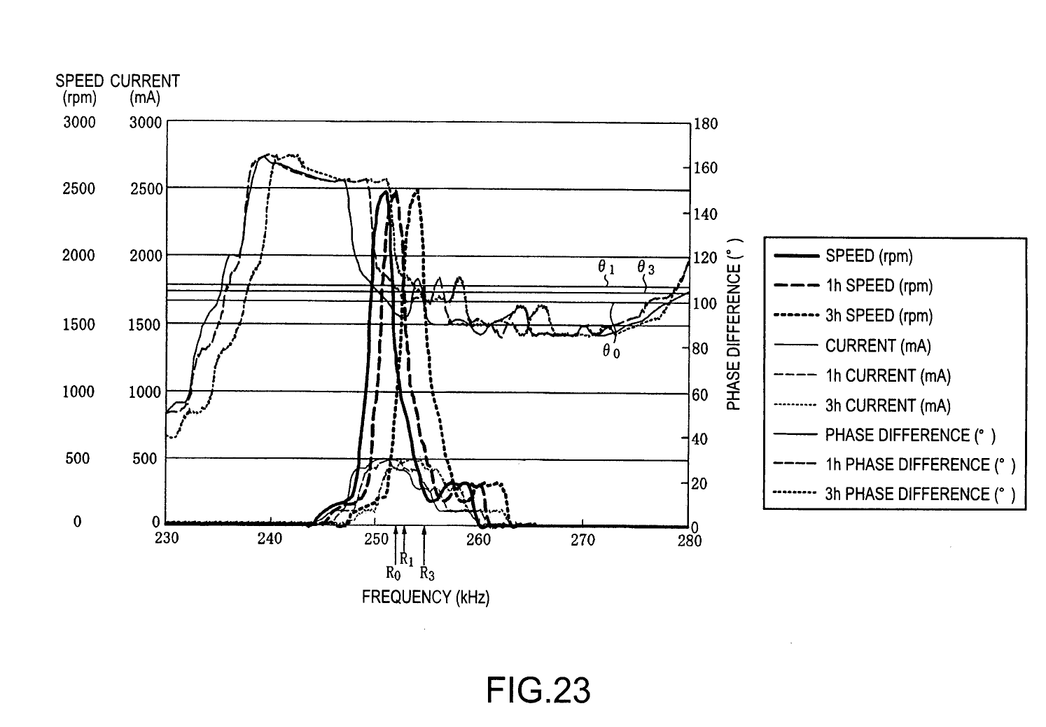

This change over time in the drive char of the 20 is shown in the graph in FIG. 23.

The speed of the rotor 30, the current supply to the piezoelectric actuator 20, and the phase difference indicated by the solid curves in FIG. 23 are the values acquired by sweeping the drive frequency (x-axis) at the initial start of piezoelectric actuator 20 operation. The speed, current, and phase difference curves indicated by the different dotted lines in FIG. 23 were acquired when sweeping the drive frequency at one and three hours after operation started.

As shown in this graph, the speed, current, and phase difference are not constant when sweeping the drive frequency, and change with time after operation starts. The resonance point of the vibrator 20A of the piezoelectric actuator 20 (that is, the drive frequency when speed is near 2500 rpm in FIG. 23) is initially R0 and gradually increases to R1 after one hour and R3 after three hours, and the speed, current, and phase difference therefore shift when sweeping the drive frequency. Causes for this shift are attributed to wear of the rotor 30 and the contact part 25 of the vibrator 20A, and change in the pressure urging the contact part 25 against the rotor 30.

When phase difference feedback control in the drive process P5 continues for a predetermined time corresponding to the time change in the drive characteristic of the piezoelectric actuator 20, the acquisition frequency control unit 654 of the controller 265 detects that the elapsed time Tn has reached continuous drive time N (step Sn37 in FIG. 21) and therefore runs the optimum phase difference acquisition process P1 and phase difference inversion detection process P4 shown in FIG. 20 again. The optimum phase difference acquisition process P1 is thus repeated when the continuous drive time (1 hour in this example) stored in the controller 65 passes, and the value defined as the optimum phase difference is thus updated. The phase difference inversion detection process P4 also repeats each time the continuous drive time (1 hour) stored in the controller 265 passes, and the phase difference inversion frequency F1 and clamping frequency F2 stored in the storage unit 658 are updated.

The value stored and used as the optimum phase difference, the phase difference inversion frequency F1, and the clamping frequency F2 are thus corrected for shifts in the resonance point over time, and the drive control device 50 can desirably control driving the piezoelectric actuator based on the updated optimum phase difference.

The piezoelectric actuator 20 can thus drive the rotor 30 in a forward direction and a reverse direction by selectively supplying drive signals to the drive electrodes 221, 222, 223 as described above, but the combined phase differences of the longitudinal vibration and sinusoidal vibration when driving in the forward direction and when driving in the reverse are not symmetrical, and the drive characteristics frequently differ when driving forward and reverse.

As a result, the optimum phase difference acquisition process P1 and phase difference inversion detection process P4 shown in FIG. 20 (where these processes P1 and P4 [P2, sic] constitute an initialization process) are executed again whenever the user causes the direction of chronograph seconds hand 7A rotation to change or the forward-reverse rotation circuit 522 (FIG. 15) inputs a signal for changing the direction of rotation to the controller 265 (Sn38 returns Yes) when, for example, a predetermined time passes or in order to adjust the displayed time.

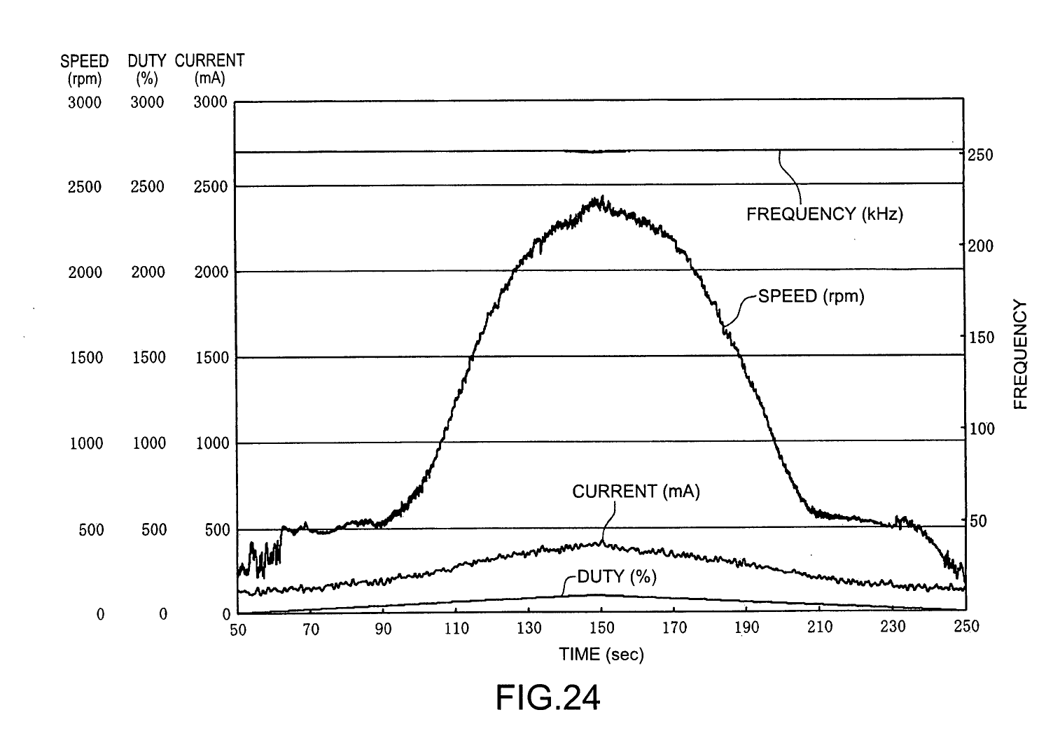

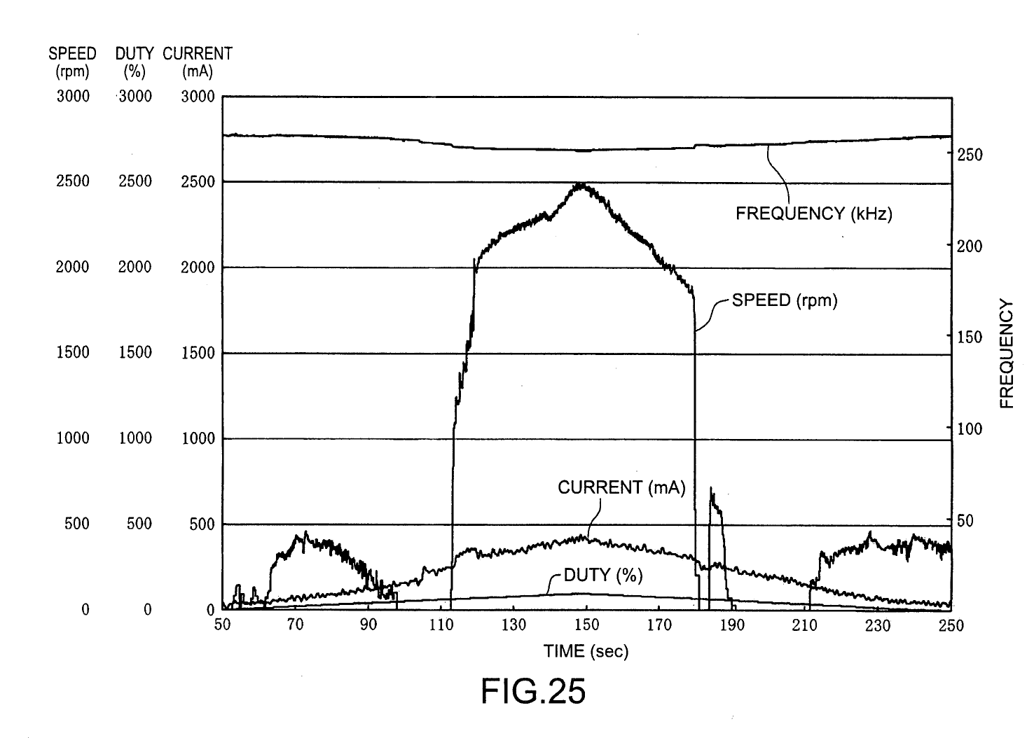

FIG. 24 is a graph of the drive characteristic of the piezoelectric actuator 20, and FIG. 25 is a graph showing the drive characteristic of the piezoelectric actuator 20 when the drive frequency is not limited for comparison with FIG. 24. The continuous drive time of the piezoelectric actuator 20 is shown on the x-axis in both FIG. 24 and FIG. 25.

When the drive frequency is limited, there is substantially no increase or decrease in the drive frequency and the speed of the rotor 30 is stable as shown in FIG. 24 even in an environment in which the vibrator 20A tends to heat up easily with continuous operation. As shown in FIG. 25, however, the drive frequency fluctuates up and down due to temperature change resulting from heat output by the vibrator 20A, rotor 30 speed does not rise when the drive frequency is rising or falling, and the drive state is extremely unstable.

More specifically, it was confirmed that by limiting the drive frequency by unit of the drive control device 50 described above, piezoelectric actuator 20 drive control is stable regardless of changes in temperature, for example.

### 2-4 Effects of this Embodiment of the Invention

This embodiment of the invention affords the following effects in addition to the effects described in the first embodiment.
(6) Even if the optimum phase difference required to achieve a desired drive state (the optimum phase difference required to achieve maximum drive efficiency in this embodiment of the invention) changes over time, the optimum phase difference is redefined and corrected to a suitable optimum phase difference each time the optimum phase difference acquisition process P1 runs as a result of the acquisition frequency control unit 654 of the controller 265 running the optimum phase difference acquisition process P1 at a predetermined frequency. Because the suitability of the optimum phase difference can thus be assured, stable drive control can be achieved in the drive process P2 based on this optimum phase difference, producing the torque required to drive the rotor 30 and achieve the desired drive efficiency.
(7) When the phase difference inversion detection unit 655 of the drive control device 50 references the data table TBL in the storage unit 658 in order to track the phase difference when controlling the drive signal frequency to follow the phase difference detected by the phase difference detection unit 60 and the drive frequency reaches the clamping frequency F2, the clamping unit 657 clamps the drive frequency tracking the phase difference and limits the drive frequency. As a result, the drive frequency can be prevented from being changed in the wrong direction when the size of the phase difference to the target phase difference θ inverts when sweeping the drive frequency, thus affording stable drive control.
(8) When the controller 265 sweeps the drive frequency, a clamping frequency F2 offset toward the optimum drive state G from the phase difference inversion frequency F1 is set, and tracking the drive frequency to the phase difference is controlled so that the drive frequency does not go to the clamping frequency F2. As a result, the drive frequency can be prevented from tracking the phase difference in the wrong direction as a result of the size of the phase difference inverting even if the drive state approaches the inversion point Pt1 as a result of change in the drive frequency.
(9) By incorporating the drive control device 50A into an electronic timepiece 1, which is a wristwatch, in which the operation of an integrated piezoelectric actuator 20 may be unstable due to variation in temperature or load, for example, the invention is particularly effective providing stable operation.

Variations of the second embodiment described above are described below. The following variations correspond to the first to third variations of the first embodiment described above.

Variation 1 of the Second Embodiment

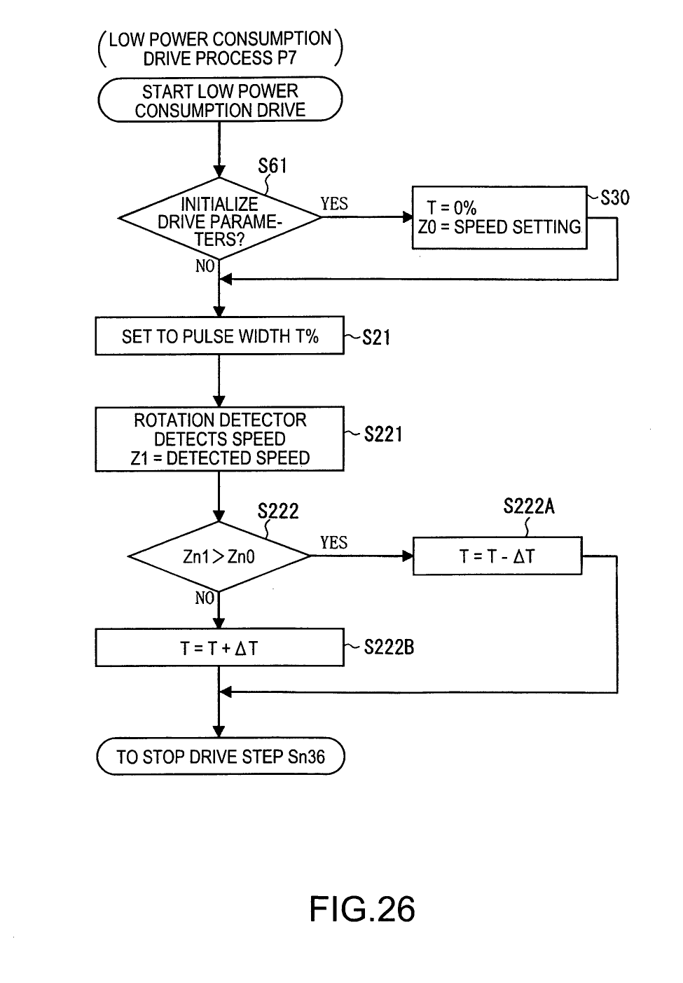

The low power consumption drive process P7 shown in FIG. 26 can be substituted for the low power consumption drive process P6 shown in FIG. 22 in the second embodiment. The process shown in FIG. 26 corresponds to the process shown in FIG. 11 as a variation of the first embodiment.

More specifically, the initialization step S10 following the drive parameter initialization evaluation step (S61) in the second embodiment described above initializes the pulse width T of the drive signal output from the controller 265 to the pulse control circuit 52 to 0%, but the initial pulse width T is not so limited. As shown in FIG. 26, the pulse width T can be initialized to 10% as the appropriate pulse width, and the drive signal pulse width can be adjusted until operation stabilizes at the rotor 30 speed setting. This shortens the piezoelectric actuator 20 startup time, reduces the time to reach the startup speed, and also reduces power consumption.

The initial pulse width of the drive signal is not limited to 10% of the appropriate pulse width, and can be set to 5% or other pulse width that is less than the appropriate pulse width and the pulse duty can be gradually increased according to the detected speed.

Variation 2 of the Second Embodiment

In the first variation of the second embodiment described above the appropriate pulse width (such as 10%) can be stored in the storage unit 651 and the appropriate pulse width stored in the storage unit 651 can be updated when operation stabilizes after startup as in the first variation of the first embodiment, or instead of saving the pulse width from just the previous startup operation, the pulse widths of the plural drive signals used to drive the rotor 30 in a steady state following a plurality of startup operations can be accumulated as the appropriate pulse width in the storage unit 651.

Variation 3 of the Second Embodiment

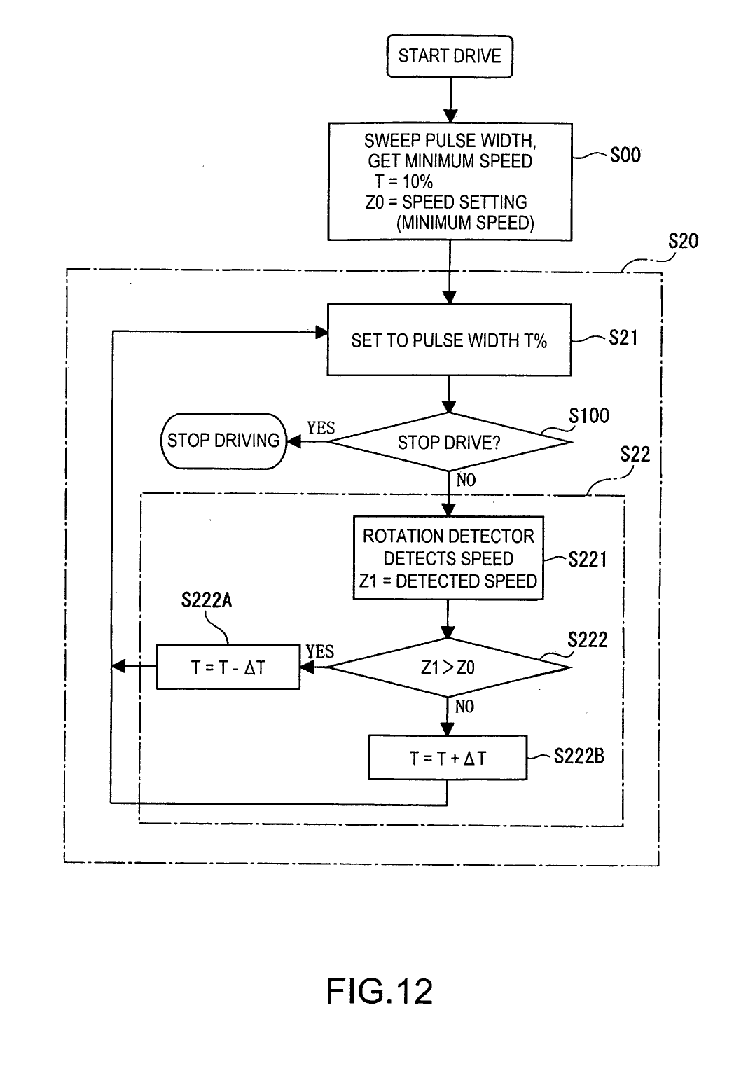

The low power consumption drive process P8 shown in FIG. 27 can also be substituted for the low power consumption drive process P6 shown in FIG. 22 in the second embodiment. The process shown in FIG. 27 corresponds to the process shown in FIG. 12 as a variation of the first embodiment.

More specifically, an initialization step S00 executed when drive control starts is provided, and this initialization step S00 can sweep the drive signal pulse width to determine the speed that achieves the desired torque.

The fourth and fifth variations of the first embodiment can also be applied to the second embodiment.

### Embodiment 3

A third embodiment of the invention is described below.

Drive control in this embodiment of the invention enables adjusting the speed of the rotor that is driven by the piezoelectric actuator 20.

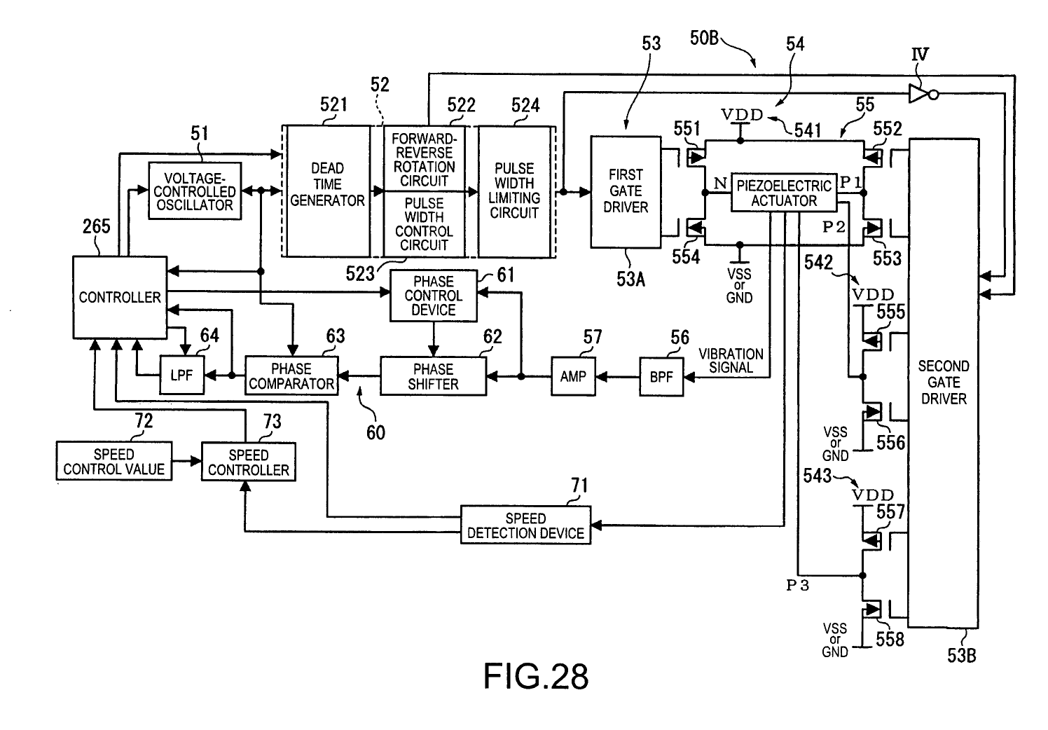

FIG. 28 shows a drive control device 50B according to this embodiment of the invention.

This drive control device 50B differs from the drive control device 50A shown in FIG. 15 by additionally having a speed control value source 72 for outputting a speed control value for the rotor, and a speed control device 73 for outputting a control signal to the controller 265 based on the speed detected by the speed detection device 71 and the speed control value output by the speed control value source 72.

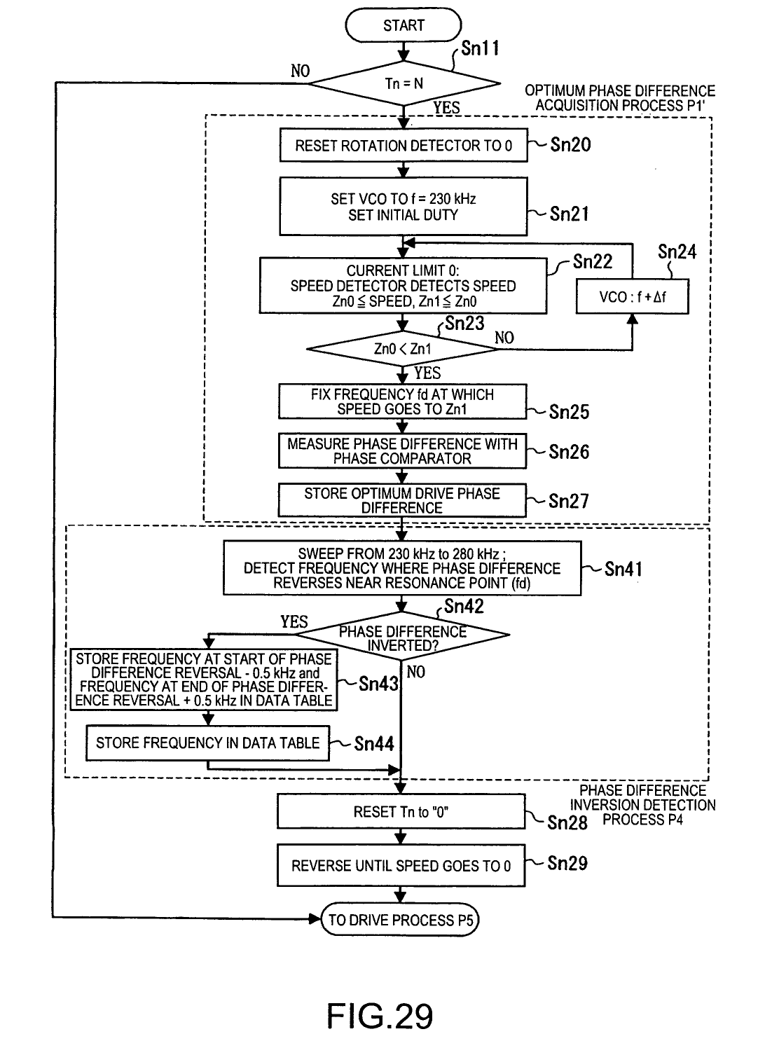

FIG. 29 is a flow chart of the optimum phase difference acquisition process P1′ in this embodiment of the invention. This optimum phase difference acquisition process P1′ first resets the speed detection device 71 to 0 (step Sn20). Steps Sn21 to Sn27 then execute in the same way as the optimum phase difference acquisition process P1 described in FIG. 20 to get the optimum phase difference (Sn27). The phase difference inversion detection process P4 then runs as described in FIG. 20 to reset the elapsed time Tn (Sn28). The speed detection device 71 continues detecting the speed of the rotor 30 while steps Sn21 to Sn28 execute.

The rotor 30, which has been turning since step Sn20, is then reversed by the speed detection device 71, speed control value source 72, and speed control device 73 until the speed goes to 0 (motion resetting step, step Sn29) As a result, a control value reflecting the time required for optimum phase difference acquisition process P1′ and phase difference inversion detection process P4 to execute is input through the timekeeping unit block of the circuit board to the speed control value source 72 when starting the drive process P5, and the speed of the rotor 30 is adjusted by the speed control device 73.

The speed detection device 71 continues detecting the speed of the rotor 30 while drive process P5 executes.

Variations of the Invention

The present invention is not limited to the embodiments described above. Several alternatives for limiting the pulse width of the drive signal are also described above, but the invention can also be varied and improved in other ways without departing from the scope of the invention.

The third embodiment is described as an arrangement that enables adjusting the rotor speed by detecting the rotor speed to control operation, but the invention is not so limited. The rotational speed of the rotor can also be adjusted by, for example, detecting the piezoelectric actuator current and controlling the current supply based on the detected current. Rotor speed can also be adjusted by detecting both the rotor speed and the piezoelectric actuator current.

When detecting both the rotor speed and piezoelectric actuator current for control, the control loop based on rotor speed is a major control loop and the control loop based on current is a minor loop. In an arrangement having a speed detection device, speed control value source, speed control device, current detection device, and current control device, the speed control device produces a current control value based on the speed control value from the speed control value source and the speed detected by the speed detection device. The current control device then outputs a control signal to the control unit based on this generated current value and the current detected by the current detection device.

The controllers 65 and 265 of the drive control device 50 and 50A in the above embodiments include a frequency control unit, an optimum phase difference acquisition unit, an acquisition frequency control unit, a phase difference inversion detection unit, a clamping unit, and a control unit including storage, but these various unit can be incorporated in separate controllers or otherwise rendered as desired. The controllers 65 and 265 can also be rendered in software instead of hardware.

The optimum phase difference is limited to maximize the piezoelectric actuator drive efficiency above, but the invention is not so limited. If operation at the maximum drive efficiency is not necessary, for example, the optimum phase difference affording a particular drive state other than maximum drive efficiency can be acquired.

These embodiments feed back the phase difference between the drive signal and detection signal and control the drive signal frequency to track this phase difference, but the drive signal frequency can be fixed to a constant frequency instead of using such phase difference feedback control.

The drive signal in these embodiments is a rectangular wave pulse, but the waveform of the drive signal could be a sine wave, a sawtooth wave, or a triangular wave, and power consumption can still be reduced by controlling the pulse width.

When acquiring the optimum phase difference at a specific frequency in the initialization step, time, a number of startup operations, or the number of times some other specific operation is executed must be counted using a suitable unit. The count can also be stored in nonvolatile memory, for example, when the piezoelectric actuator is not driven so that counting resumes when the piezoelectric actuator is restarted. This eliminates the need to unconditionally execute the optimum phase difference acquisition process whenever the piezoelectric actuator starts, and enables accumulating the drive time or count when driving the piezoelectric actuator starts and stops at short intervals so that the optimum phase difference, which can vary over time with wear, can be acquired at a predetermined frequency.

The frequency at which the optimum phase difference acquisition process P1 is executed is controlled by the acquisition frequency control unit to an interval of one hour in each of the preceding embodiments, but the time set as this acquisition frequency is not limited to one hour. This interval can more particularly be set to any range from multiple minutes to multiple hours according to the size of the load of the driven body. The acquisition frequency can also be adjusted according to the elapsed time since operation started to, for example, increase the frequency as the time since operation started increases, that is, to execute the optimum phase difference acquisition process at shorter time intervals.

The frequency of the optimum phase difference acquisition process can also be defined on a basis other than time. More specifically, the frequency can also be defined in terms of how many times the piezoelectric actuator is started so that, for example, the frequency is set to 255 startup operations and is stored in memory in the controller. The frequency can also be set according to when the piezoelectric actuator is assembled in the electronic device. This assembly time includes replacing the piezoelectric actuator due to wear of the contact part between the vibrator and the driven body.

The method of determining this frequency can be suitably decided according to the load of the driven body or the operating mode of the piezoelectric actuator, for example. The frequency can also be set separately for forward and reverse rotation of the rotor.

The present invention is also not limited to being used in timepieces, and is suitable for use in various electronic devices, particularly portable electronic devices for which small size is essential.

Examples of such electronic devices include telephones with a clock function, cell phones, contactless IC cards, notebook computers, personal digital assistants (PDA), and cameras.

The invention can also be used in cameras that do not have a clock function, in digital cameras, video cameras, cell phones with a built-in camera function, and other electronic devices. When used in an electronic device with a camera function, the drive unit of the present invention can be used to drive the lens focusing mechanism, zoom mechanism, and aperture control mechanism.

The drive unit of the present invention can also be used in the meter needle drive mechanism of measuring instruments, the meter needle drive mechanism for the instrument panel of an automobile, piezoelectric buzzers, inkjet printer heads, the paper feed mechanism in printers, the drive mechanism or attitude correction mechanism in movable toys such as dolls and riding toys, ultrasonic motors, and other applications.

The piezoelectric actuator 20 is used in the above embodiments to drive a date display device 90 that presents calendar information, but the invention is not so limited. More particularly, the piezoelectric actuator of the invention can be used to drive a mechanism for displaying the year, month, or weekday, or to drive the hour hand 4, minute hand 5, and second hand 6 that display the time.

The type of timepiece is also not limited to a wristwatch, and could be a pocket watch, a wall clock, or a mantle clock, for example. The invention can also be used to drive automata in such timepieces.

The driven body can be a rotor that is driven rotationally or a linearly moving body that is driven in a straight line, and the direction in which the driven body is driven is not limited.

The best modes and methods of achieving the present invention are described above, but the invention is not limited to these embodiments. More specifically, the invention is particularly shown in the figures and described herein with reference to specific embodiments, but it will be obvious to one with ordinary skill in the related art that the shape, material, number, and other detailed aspects of these arrangements can be varied in many ways without departing from the technical concept or the scope of the objective of this invention.

Therefore, description of specific shapes, materials and other aspects of the foregoing embodiments are used by way of example only to facilitate understanding the present invention and in no way limit the scope of this invention, and descriptions using names of parts removing part or all of the limitations relating to the form, material, or other aspects of these embodiments are also included in the scope of this invention.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application Nos:2006-002795, filed Jan. 10, 2006 and 2006-227220, filed Aug. 23, 2006 are expressly incorporated by reference herein.

What is claimed is:

1. A drive control method for a piezoelectric actuator having a vibrator that vibrates when a drive signal is applied to a piezoelectric element and transfers the vibration of the vibrator to a driven body, wherein:
the vibrator vibrates in a combination of plural vibration modes when a rectangular-wave, single-phase drive signal is applied;
the drive control method comprising steps of:
producing the drive signal with a reference pulse width achieving a maximum drive power determined according to the drive characteristics when the piezoelectric actuator drives the driven body; and
limiting the drive signal pulse width relative to the reference pulse width to the minimum pulse width that achieves the minimum drive power required to drive the driven body based on the drive characteristics.

2. The piezoelectric actuator drive control method described in claim 1, wherein:
the vibrator is substantially rectangular in plan view; and
the plural vibration modes of the vibrator are a longitudinal vibration mode of expansion and contraction lengthwise to the vibrator and a sinusoidal vibration mode of expansion and contraction at an angle to the longitudinal vibration.

3. The piezoelectric actuator drive control method described in claim 1, further comprising steps of:
sweeping the drive signal pulse width and acquiring an appropriate pulse width that achieves a specified drive power; and
controlling the drive signal to the appropriate pulse width.

4. The piezoelectric actuator drive control method described in claim 1, further comprising a step of:
initializing the drive signal pulse width at startup to the appropriate pulse width that achieves the specified drive power.

5. The piezoelectric actuator drive control method described in claim 4, further comprising a step of:
setting the appropriate pulse width to the drive signal pulse width at which driven body operation was stable when the driven body was driven after the last startup.

6. The piezoelectric actuator drive control method described in claim 1, further comprising a step of:
adjusting the drive signal pulse width based on detecting a drive state of the piezoelectric actuator.

7. The piezoelectric actuator drive control method described in claim 6, further comprising, in addition to a drive process of limiting the drive signal pulse width to a reference pulse width, an initialization process comprising:
an optimum phase difference acquisition step for frequency sweeping the drive signal to find the phase difference between the drive signal and a detection signal denoting the detected drive state as an optimum phase difference that achieves a predetermined drive state; and
a phase difference inversion detection step for detecting the phase difference between the drive signal and detection signal while frequency sweeping the drive signal in a predetermined direction through a predetermined range that includes the frequency achieving the predetermined drive state, and detecting the phase difference inversion frequency at which the detected phase difference returns to the optimum phase difference;
wherein the drive process causes the drive signal frequency to track the phase difference by limiting the drive signal frequency so that the drive signal frequency does not go to a clamping frequency that is set to a value on a specific drive state side of the phase difference inversion frequency, detecting the phase difference between the drive signal and detection signal, and increasing or decreasing the drive signal frequency based on whether the phase difference is greater than or less than the optimum phase difference; and
the initialization process executes at a predetermined frequency to update the optimum phase difference and phase difference inversion frequency.

8. A drive control device for a piezoelectric actuator having a vibrator that vibrates when a drive signal is applied to a piezoelectric element and transfers the vibration of the vibrator to a driven body, wherein:
the vibrator vibrates in a combination of plural vibration modes when a rectangular-wave, single-phase drive signal is applied;
the drive control device comprising:
a drive signal source for producing the drive signal with a reference pulse width achieving a maximum drive power determined according to the drive characteristics when the piezoelectric actuator drives the driven body; and
a control unit for limiting the drive signal pulse width relative to the reference pulse width to the minimum pulse width that achieves the minimum drive power required to drive the driven body based on the drive characteristics.

9. The piezoelectric actuator drive control device described in claim 8, wherein:
the vibrator is substantially rectangular in plan view; and
the plural vibration modes of the vibrator are a longitudinal vibration mode of expansion and contraction lengthwise to the vibrator and a sinusoidal vibration mode of expansion and contraction at an angle to the longitudinal vibration.

10. The piezoelectric actuator drive control device described in claim 8, further comprising:
a storage unit for storing an appropriate pulse width that achieves a specified drive power.

11. The piezoelectric actuator drive control device described in claim 8, further comprising:
a detection unit for detecting the drive state of the piezoelectric actuator;
wherein the control unit adjusts the drive signal pulse width based on the drive state.

12. The piezoelectric actuator drive control device described in claim 11, further comprising:
an initialization unit comprising
a phase difference detection unit for detecting a phase difference between the drive signal and a detection signal denoting the drive state detected by the detection unit,
an optimum phase difference acquisition unit for frequency sweeping the drive signal to find an optimum phase difference that is the phase difference achieving a predetermined drive state based on phase difference detection by the phase difference detection unit, and
a phase difference inversion detection unit for detecting the phase difference between the drive signal and detection signal while frequency sweeping the drive signal in a predetermined direction through a predetermined range that includes the frequency achieving the predetermined drive state, and detecting the phase difference inversion frequency at which the detected phase difference returns to the optimum phase difference;
a frequency control unit for setting the drive signal frequency based on the optimum phase difference; and
an acquisition frequency control unit for updating the optimum phase difference and the phase difference inversion frequency by executing the process of the initialization unit at a predetermined frequency;
wherein the frequency control unit comprises a clamping unit for limiting the drive signal frequency so that the drive signal frequency does not go to a clamping frequency that is set to a value on a specific drive state side of the phase difference inversion frequency, and
causes the drive signal frequency to track the phase difference by limiting the drive signal frequency by unit of the clamping unit while detecting the phase difference by unit of the phase difference detection unit and increasing or decreasing the drive signal frequency based on whether the phase difference is greater than or less than the optimum phase difference.

13. An electronic device comprising:
a piezoelectric actuator;
a driven body that is driven by the piezoelectric actuator; and
the piezoelectric actuator drive control device described in claim 9.

14. The electronic device described in claim 13, wherein the electronic device is a timepiece comprising a timekeeping unit and a time display unit for displaying time information kept by the timekeeping unit.

15. A drive control device for a piezoelectric actuator having a vibrator that vibrates when a drive signal is applied to a piezoelectric element and transfers the vibration of the vibrator to a driven body, wherein:
the vibrator vibrates in a combination of plural vibration modes when a rectangular-wave, single-phase drive signal is applied;
the drive control device comprising:
a drive signal source for producing the drive signal with a reference pulse width achieving a maximum drive power determined according to the drive characteristics when the piezoelectric actuator drives the driven body; and
a control means for limiting the drive signal pulse width relative to the reference pulse width to the minimum pulse width that achieves the minimum drive power required to drive the driven body based on the drive characteristics.

16. The piezoelectric actuator drive control device described in claim 15, further comprising:
an initialization means comprising
a phase difference detection means for detecting a phase difference between the drive signal and a detection signal denoting the drive state detected by the detection means,
an optimum phase difference acquisition means for frequency sweeping the drive signal to find an optimum phase difference that is the phase difference achieving a predetermined drive state based on phase difference detection by the phase difference detection means, and
a phase difference inversion detection means for detecting the phase difference between the drive signal and detection signal while frequency sweeping the drive signal in a predetermined direction through a predetermined range that includes the frequency achieving the predetermined drive state, and detecting the phase difference inversion frequency at which the detected phase difference returns to the optimum phase difference;
a frequency control means for setting the drive signal frequency based on the optimum phase difference; and
an acquisition frequency control means for updating the optimum phase difference and the phase difference inversion frequency by executing the process of the initialization means at a predetermined frequency;
wherein the frequency control means comprises a clamping means for limiting the drive signal frequency so that the drive signal frequency does not go to a clamping frequency that is set to a value on a specific drive state side of the phase difference inversion frequency, and
causes the drive signal frequency to track the phase difference by limiting the drive signal frequency by means of the clamping means while detecting the phase difference by means of the phase difference detection means and increasing or decreasing the drive signal frequency based on whether the phase difference is greater than or less than the optimum phase difference.
